(19) United States
(12) Patent Application Publication
(10) Pub. No.: US 2022/0216523 A1
(43) Pub. Date: Jul. 7, 2022

(54) THIN LITHIUM BATTERY AND METHOD FOR MANUFACTURING SAME

(71) Applicant: UBATT INC., Seoul (KR)

(72) Inventors: Chang Kyoo LEE, Seoul (KR); Keun Ho CHOI, Daejeon (KR); Jung Hwan KIM, Daejeon (KR); Jung Mo LEE, Daejeon (KR)

(21) Appl. No.: 17/594,997

(22) PCT Filed: Feb. 4, 2021
(86) PCT No.: PCT/KR2021/001453

§ 371 Date: Nov. 4, 2021

(30) Foreign Application Priority Data
Feb. 5, 2020 (KR) 10-2020-0013491
Feb. 1, 2021 (KR) 10-2021-0014167

(51) Int. Cl. H01M 10/0585; H01M 4/70; H01M 4/62; H01M 10/0565; H01M 50/531; H01M 50/181

(52) U.S. Cl. CPC H01M 10/0585; H01M 4/70; H01M 4/62; H01M 2004/027; H01M 50/531; H01M 50/181; H01M 10/0565

(57) ABSTRACT

Provided is a thin lithium battery and a method for manufacturing the same. Specifically, the present invention relates to a thin lithium battery having a tabless current collecting structure that does not require a separate tab or terminal unit because a current collector is exposed to the outside, and a method for manufacturing the same. In addition, the present invention relates to a thin lithium battery and a method for manufacturing the same, wherein the thin lithium battery has flexibility and can thus be applied to flexible devices, and does not require a separate terminal unit and can thus be manufactured into a wide variety of dimensions and designs by punching, such as by cutting, stamping, or laser cutting.

### TECHNICAL FIELD

The present invention relates to a thin lithium battery and a method for manufacturing the same, and more particularly, to a thin lithium battery having a tabless current collecting structure that does not require a separate tab or terminal unit because a current collector is exposed to the outside, and a method for manufacturing the same. In addition, the present invention relates to a thin lithium battery and a method for manufacturing the same, wherein the thin lithium battery has flexibility and may thus be applied to flexible devices, and does not require a separate terminal unit and can thus be manufactured into a wide variety of dimensions and designs by punching, such as by cutting, stamping, or laser cutting.

### BACKGROUND ART

Energy-related technologies are being actively studied as the industry related to portable electronic devices has recently expanded with the development of communication technology and semiconductor manufacturing technology, and the demand for development of alternative energy to prepare for the depletion of fossil fuels and to preserve the environment is rapidly increasing. In these energy-related technologies, a battery, which is a representative energy storage device, are emerging as core technologies.

Among the batteries, a lithium primary battery has a higher voltage and higher energy density than a conventional aqueous-based battery, and thus, is easy to reduce a size and weight. As a result, the lithium primary battery has been widely applied. Such a lithium primary battery is mainly used for a main power source or a backup power source of a portable electronic device. A lithium secondary battery, which is another battery, is an energy storage device capable of charging/discharging using an electrode material having excellent reversibility.

The lithium secondary batteries are being manufactured in various shapes according to their applications. For example, the lithium secondary batteries are packaged and manufactured in cylindrical, prismatic, pouch types, and the like. Here, since the pouch type secondary battery may be lightened, related technologies are being continuously developed. In general, the pouch type lithium secondary battery may be manufactured by housing an electrode assembly inside a pouch case having a space for housing the electrode assembly and then sealing the pouch case to form a pouch bare cell, and attaching accessories such as a protection circuit module to the pouch bare cell to form a pouch core pack.

However, such a pouch type lithium secondary battery also becomes a factor limiting the shape and size of the lithium secondary battery in terms of packaging. Further, since the conventional pouch type lithium secondary battery should include electrode tabs, each electrode needs to be connected to the tab, it is impossible to package several batteries at a time, manufacturing is difficult, productivity is lowered, and it is difficult to apply to various electronic products.

In addition, in the era of the Internet of Things (IoT), the demand for thin power sources of various designs that may be used in low-power, small-capacity devices is increasing, but there is a disadvantage in that the existing coin cells have a uniform design and a thick thickness. In addition, the existing pouch thin type batteries also have a uniform design and tabs, so production is complicated and the price is high. Accordingly, there is a need for a power source having a free shape, a thin thickness, and a competitive price.

### DISCLOSURE

### Technical Task

An object of the present invention is to provide a thin lithium battery having the effect of implementing mass production and reducing production cost by continuously performing a battery production and packaging process.

In addition, an object of the present invention is to provide a thin lithium battery capable of preventing a short circuit from occurring because a separator may be formed to have a larger size than a positive electrode, and thus lithium metal is formed on a negative electrode current collector as much as a size of a positive electrode during charging and discharging, and a method for manufacturing the same.

In addition, an object of the present invention is to provide a thin lithium battery that does not require a separate tab or a terminal unit by exposing a current collector to the outside or exposing a metal layer constituting a package, which is in close contact with the current collector and electrically connected to the current collector, to the outside, and a method for manufacturing the same.

In addition, an object of the present invention is to provide a thin lithium battery capable of reducing material cost by not requiring a separate packaging material for a negative electrode, and a method for manufacturing the same. That is, an object of the present invention provides a thin lithium battery in which a negative electrode current collector can actually serve as a packaging material, and a method for manufacturing the same.

In addition, an object of the present invention is to provide a thin lithium battery capable of diversifying a design of a battery by making it possible to manufacture the battery in various shapes such as circular, semi-circular, triangular, quadrangular, and star shapes without any restrictions on a design of a battery without needing a terminal unit, and a method for manufacturing the same.

In addition, an object of the present invention is to provide a thin lithium battery that is manufactured by using a negative electrode current collector provided with a plurality of battery cell areas by a barrier rib pattern, disposing a plurality of separators and positive electrodes in the cell areas, and laminating upper sheets by heat, thereby forming the plurality of battery cells at a time and dividing the battery cells to facilitate manufacturing of a plurality of batteries, and a method for manufacturing the same.

In addition, the present invention is to provide a thin lithium battery that has a tabless current collecting structure with reduced current collecting resistance and suppresses a surface oxide film from being formed because a metal layer containing lithium is not exposed to the atmosphere during a battery assembly process, and a method for manufacturing the same.

### Technical Solution

In order to achieve the above object, the present invention provides a thin lithium battery of a tabless current collecting structure.

In one general aspect, there is provided a thin lithium battery including an upper sheet, a positive electrode, a first separator, and a negative electrode current collector which are sequentially stacked,

in which the positive electrode is a positive electrode-electrolyte conjugate in which a positive electrode active material layer including a lithium complex oxide and a first gel polymer electrolyte are integrated on a positive electrode current collector, and the positive electrode current collector is in close contact with the upper sheet,

the first separator has substantially the same size as the positive electrode or is larger than the positive electrode, and is a separator-electrolyte conjugate integrated with a second gel polymer electrolyte,

the negative electrode current collector includes a barrier rib provided on a circumferential portion of an upper surface thereof to be sealed in close contact with the upper sheet, and the positive electrode and the first separator are housed in a space sealed by the barrier rib, and

a lithium metal layer integrated with the negative electrode current collector is provided between the negative electrode current collector and the first separator.

In another general aspect of the present invention, a method for manufacturing a thin lithium battery includes:

(S1) preparing a positive electrode-electrolyte conjugate including a first gel polymer electrolyte by applying and gellating a first gel polymer electrolyte composition on a positive electrode;

(S2) preparing a first separator-electrolyte conjugate including a second gel polymer electrolyte by applying and gellating a second gel polymer electrolyte composition on a first separator;

(S3) cutting the positive electrode-electrolyte conjugate and the first separator-electrolyte conjugate;

(S4) stacking a barrier rib sheet formed with a barrier rib pattern partitioned into a cell area having one or a plurality of openings on an upper surface of a negative electrode current collector;

(S5) forming a structure in which the first separator-electrolyte conjugate and the positive electrode-electrolyte conjugate are disposed in each of the one or a plurality of cell areas, and the negative electrode current collector, the first separator-electrolyte conjugate and the positive electrode-electrolyte conjugate are stacked;

(S6) stacking an upper sheet on the stacked structure; and

(S7) charging one or a plurality of cells.

### Advantageous Effects

According to the present invention, a thin lithium battery may be continuously produced by disposing a separator and a positive electrode punched in a predetermined shape to be housed in the plurality of cell areas on a negative electrode current collector provided with a plurality of cell areas that are continuously supplied, thereby greatly improving productivity. In addition, a battery may be manufactured by a relatively easy and simple method such as application and injection without a vacuum process by using a gel polymer electrolyte without using a liquid electrolyte, and a production speed may be improved with a simplified process.

According to the present invention, a current collector is exposed to the outside, and thus, a separate tab or terminal unit is not required, a size, a location, and the like of the terminal unit need not be considered, and a cost reduction effect is obtained by removing the terminal unit. In addition, it is possible to manufacture a thin lithium battery in various shapes and dimensions, such as circular, semi-circular, triangular, quadrangular, and star shapes, by methods such as punching and laser cutting.

According to the present invention, at least one surface of a negative electrode current collector exposed to the outside may extend in a surface direction and also serve as a packaging material, and thus, a packaging layer provided in addition to the outermost layer of the negative electrode current collector like a normal battery may not be required.

In addition, according to the present invention, a grain boundary resistance of a battery may be reduced and ion conductivity may be improved by using a positive electrode and a separator in which a gel polymer electrolyte is integrated, thereby providing a more advantageous effect of implementing improved lifespan characteristics and improving safety.

In addition, according to the present invention, it is possible to block occurrence of a short circuit of a battery by the lithium metal layer generated during charging and discharging by forming a separator to have a larger size than a positive electrode.

### DESCRIPTION OF DRAWINGS

FIG. 1 is a cross-sectional view of a thin lithium battery according to an embodiment of the present invention, and illustrates a case in which a separator has a larger size than a positive electrode;

FIG. 2 is a cross-sectional view of the thin lithium battery according to the embodiment of the present invention, and illustrates a case in which the separator has a substantially equal size to the positive electrode;

FIG. 3 is a cross-sectional view of the thin lithium battery according to the embodiment of the present invention, and illustrates a case in which the number of separators is two;

FIG. 4 is a cross-sectional view of the thin lithium battery according to the embodiment of the present invention, and illustrates a case in which a joint is formed in a portion where an upper sheet and a positive electrode current collector are in close contact;

FIG. 5 is a cross-sectional view of the thin lithium battery according to the embodiment of the present invention, and illustrates a case in which a conductive layer is provided between the upper sheet and the positive electrode current collector;

FIG. 6 is a cross-sectional view of the thin lithium battery according to the embodiment of the present invention, and illustrates a case in which a lower sheet which is in close contact with and adheres to the negative electrode current collector is further provided on a lower surface of the negative electrode current collector;

FIG. 7 is an SEM photograph of observing a surface of a lithium metal layer formed on the negative electrode current collector in a case where a gel polymer electrolyte is used; and

FIG. 8 is an SEM photograph of the surface of the lithium metal layer formed on the negative electrode current collector when a liquid electrolyte is used.

### EMBODIMENTS

Hereinafter, the present invention will be described in more detail through specific examples or embodiments including the accompanying drawings. However, the following specific examples or embodiments are only one reference for describing the present invention in detail, and the present invention is not limited thereto, and may be implemented in various forms.

Further, unless otherwise defined, all technical and scientific terms have the same meaning as commonly understood by one of ordinary skill in the art to which the present invention belongs. The terms used in the description in the present invention are merely for effectively describing specific examples, and are not intended to limit the invention.

In addition, a singular form used in the specification and the appended claims may be intended to include a plural form unless otherwise indicated in the context.

In addition, unless explicitly described to the contrary, “including” any component will be understood to imply the inclusion of other components rather than the exclusion of other components.

In the present invention, the term ‘thin lithium battery’ refers to a thin battery in which a positive electrode, a separator, and a negative electrode are stacked, and specifically refers to a film-type lithium battery having a thickness of 2 mm or less capable of electrochemical reaction. In addition, since the positive electrode and the negative electrode are configured in the form of a thin film, the battery itself may have very flexible properties.

In the present invention, the term ‘substantially’ takes into account an error range that may occur during a manufacturing process, and means that an error range is within ±100 μm. That is, what edges are substantially coincident means that the edges are completely coincident or that the error range is within ±100 μm.

In the present invention, the term ‘conjugate’ means chemically and physically bound and integrated. Specifically, the ‘electrolyte conjugate’ means that a gel polymer electrolyte is applied or injected on a positive electrode or a separator and then cured or gelled and integrated, or a positive electrode material or a separator material is complexed with the gel polymer electrolyte and integrated.

In the present invention, the term ‘laminate’ means that each layer is chemically and physically bonded while being maintained as it is and stacked.

In the present invention, the term ‘gelation’ means physical crosslinking formed by entanglement between polymer chains or partial molecular orientation of the polymer chains, chemical crosslinking according to a network structure entangled by chemical bonds, or composite crosslinking in which the physical crosslinking and the chemical crosslinking are mixed.

In the present invention, the term ‘different in ionic conductivity’ means that the ionic conductivity differs by 0.1 mS/cm or more due to a difference in a type, concentration, or content of materials constituting a gel polymer electrolyte. A method for measuring ionic conductivity will be described in more detail in the following embodiment.

One aspect of the present invention relates to a thin lithium battery, in which an upper sheet, a positive electrode, a first separator, and a negative electrode current collector are sequentially stacked,

the positive electrode is a positive electrode-electrolyte conjugate in which a positive electrode active material layer including a lithium complex oxide and a first gel polymer electrolyte are integrated on a positive electrode current collector, and the positive electrode current collector is in close contact with the upper sheet,

the first separator has substantially the same size as the positive electrode or is larger than the positive electrode, and is a separator-electrolyte conjugate integrated with a second gel polymer electrolyte,

the negative electrode current collector includes a barrier rib provided on a circumferential portion of an upper surface thereof to be sealed in close contact with the upper sheet, and the positive electrode and the first separator are housed in a space sealed by the barrier rib, and

a lithium metal layer integrated with the negative electrode current collector is provided between the negative electrode current collector and the first separator.

In one aspect of the present invention, the thin lithium battery further includes a second separator provided between the first separator and the positive electrode, in which the second separator may be housed in the space sealed by the barrier rib, and may have substantially the same size as the positive electrode.

In one aspect of the present invention, the upper sheet may be formed of a metal layer, and the positive electrode current collector and the metal layer may be in close contact with each other to be electrically connected to each other.

In one aspect of the present invention, at least one or more joints may be further provided in a portion in which the positive electrode current collector and the metal layer are in close contact with each other.

In one aspect of the present invention, the thin lithium battery may further include at least one conductive layer selected from a conductive adhesive layer, a conductive pressure-sensitive adhesive layer, a conductive paste layer, and an anisotropic conductive layer provided between the positive electrode current collector and the metal layer.

In one aspect of the present invention, the upper sheet may further include an insulating layer on an outermost layer, and a portion of the insulating layer may be opened.

In one aspect of the present invention, the upper sheet may be a laminate including a barrier layer and a sealing layer, the barrier layer may be made of a metal foil or a polymer material, the sealing layer is made of an insulating material, and made of a material that is adhered in close contact with the positive electrode current collector and one surface of upper portions of the barrier rib, and an opening may be formed in a portion of the upper sheet so that a portion of the positive electrode current collector is exposed to the outside.

In one aspect of the present invention, the upper sheet may further include a base layer, which is made of an insulating material, on an upper portion of the barrier layer.

In one aspect of the present invention, the thin lithium battery may further include a lower sheet adhered in close contact with the negative electrode current collector, in which an opening may be formed in a portion of the lower sheet so that a portion of the negative electrode current collector is exposed to an outside.

In one aspect of the present invention, the lithium metal layer may have a thickness of 1 to 100 μm. More specifically, the lithium metal layer may be generated by charging after battery assembly, and in this case, the lithium metal layer may have a porous flat structure.

In one aspect of the present invention, the negative electrode current collector may be any one or a combination of two or more selected from the group consisting of aluminum, stainless steel, copper, nickel, and titanium.

In one aspect of the present invention, the negative electrode current collector may be a laminate including a first negative electrode metal layer and a second negative electrode metal layer, the first negative electrode metal layer may be any one or a combination of two or more selected from the group consisting of copper, nickel, and stainless steel, the second negative electrode metal layer may be any one or a combination of two or more selected from the group consisting of aluminum, stainless steel, copper, nickel, and titanium, and the first negative electrode metal layer and the second negative electrode metal layer may have different compositions.

In one aspect of the present invention, the negative electrode current collector may further include a terminal unit extending further than an outer end of the barrier rib.

In one aspect of the present invention, the metal layer of the upper sheet may further include a terminal unit extending further than an outer end of the barrier rib.

In one aspect of the present invention, the positive electrode current collector may be a laminate including a first positive electrode metal layer and a second positive electrode metal layer, and the first positive electrode metal layer and the second positive electrode metal layer may have different compositions.

In one aspect of the present invention, the first gel polymer electrolyte and the second gel polymer electrolyte may include a solvent and a dissociable salt, and the first gel polymer electrolyte and the second gel polymer electrolyte may be a polymer matrix that further includes any one or two or more selected from the group consisting of a linear polymer and a crosslinked polymer.

In one aspect of the present invention, the first gel polymer electrolyte and the second gel polymer electrolyte may be each applied, gelled, and then integrated.

In one aspect of the present invention, the first gel polymer electrolyte and the second gel polymer electrolyte may have different ionic conductivity.

In one aspect of the present invention, ionic conductivity IC₁ of the first gel polymer electrolyte and ionic conductivity IC₂ of the second gel polymer electrolyte may satisfy Equation 1 below.

IC₁−IC₂≥0.1 mS/cm [Equation 1]

In one aspect of the present invention, the first gel polymer electrolyte and the second gel polymer electrolyte may be different in at least one of a type of solvent; a type or concentration of dissociable salt; a type or content of linear polymer; and a type or content of crosslinked polymer.

In one aspect of the present invention, the first gel polymer electrolyte and the second gel polymer electrolyte may further include a performance enhancing agent, and a type or concentration of the performance enhancing agent of the first gel polymer electrolyte and the second gel polymer electrolyte may be different.

In another aspect of the present invention, a method for manufacturing a thin lithium battery includes:

(S1) preparing a positive electrode-electrolyte conjugate including a first gel polymer electrolyte by applying and gellating a first gel polymer electrolyte composition on a positive electrode;

(S2) preparing a first separator-electrolyte conjugate including a second gel polymer electrolyte by applying and gellating a second gel polymer electrolyte composition on a first separator;

(S3) cutting the positive electrode-electrolyte conjugate and the first separator-electrolyte conjugate;

(S4) stacking a barrier rib sheet formed with a barrier rib pattern partitioned into a cell area having one or a plurality of openings on an upper surface of a negative electrode current collector;

(S5) forming a structure in which the first separator-electrolyte conjugate and the positive electrode-electrolyte conjugate are disposed in each of the one or a plurality of cell areas, and the negative electrode current collector, the first separator-electrolyte conjugate and the positive electrode-electrolyte conjugate are stacked;

(S6) stacking an upper sheet on the stacked structure; and

(S7) charging one or a plurality of cells.

In one aspect of the present invention, the manufacturing method may include preparing a positive electrode-electrolyte-second separator laminate by stacking a second separator on the positive electrode-electrolyte conjugate in the operation (S1), and in the operations (S3) and (S5), the positive electrode-electrolyte conjugate may be a positive electrode-electrolyte-second separator laminate.

In one aspect of the manufacturing method of the present invention, in the operation (S7), a lithium metal layer integrated with the negative electrode current collector may be formed on the negative electrode current collector by charging.

Hereinafter, each configuration of the present invention will be described in more detail with reference to the drawings.

In the thin lithium battery according to one aspect of the present invention, since the negative electrode current collector is exposed to the outside, the upper sheet in close contact with the positive electrode current collector may be formed of a metal layer, and thus, a separate terminal unit may not be required. However, a separate terminal unit may be further added if necessary, and therefore, is not excluded. As the separate terminal unit is not required, the thin lithium battery has characteristics that it may be manufactured in various sizes and shapes. In addition, since the thin lithium battery is thin and flexible, it may be applied to various fields. In addition, the integrated lithium metal layer is formed on the negative electrode current collector by charging, and an electron distribution of the lithium metal layer may be more uniformly formed due to such a structure.

In addition, even when lithium ions are deposited under a low current density (low charging rate), lithium ions released from the positive electrode may be easily captured and the lithium ions returning to the positive electrode may be recaptured. Even in this case, uniform deposition is possible due to a large number of lithium ions, so an ultra-thin coating, that is, an ultra-thin lithium metal layer, may provide a negative electrode integrated with the negative electrode current collector inside the battery.

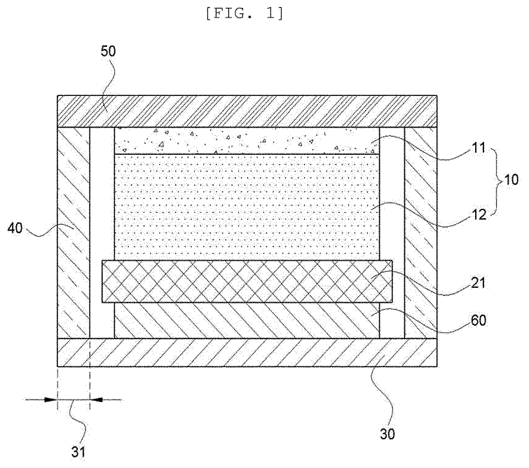

First, a stacked structure of the thin lithium battery of the present invention will be described in detail with reference to the drawings. FIGS. 1 to 6 illustrate one aspect of the present invention, but the present invention is not limited thereto.

[First Aspect of Thin Lithium Battery]

FIG. 1 is a cross-sectional view of a thin lithium battery 1000 according to an embodiment of the present invention, and illustrates a case in which a separator has a larger size than a positive electrode.

The thin lithium battery 1000 according to a first aspect of the present invention has a structure in which a negative electrode current collector is exposed to the outside as illustrated in FIG. 1. Specifically, an upper sheet 50, a positive electrode 10, a first separator 21 and a negative electrode current collector 30 are sequentially stacked from the top, and a lithium metal layer 60 integrated with the negative electrode current collector is provided between the negative electrode current collector 30 and the first separator 21. In this case, the lithium metal layer 60 may be formed by first charging after assembling the battery. Also, the upper sheet 50 and the negative electrode current collector 30 may be sealed by a barrier rib 40.

In the first aspect of the present invention, as illustrated in FIG. 1, the positive electrode 10 is a positive electrode-electrolyte conjugate having a composite active material layer 12 in which a positive electrode active material layer including a lithium complex oxide and a first gel polymer electrolyte are integrated on a positive electrode current collector 11, and the positive electrode current collector 11 is in close contact with the upper sheet 50, the first separator 21 is larger than the positive electrode 10, and is a separator-electrolyte conjugate integrated with a second gel polymer electrolyte, the negative electrode current collector 30 includes a barrier rib 40 provided on a circumferential portion 31 of an upper surface thereof to be sealed in close contact with the upper sheet 50, and the positive electrode 10 and the first separator 21 are housed in a space sealed by the barrier rib 40, and a lithium metal layer 60 integrated with the negative electrode current collector is provided between the negative electrode current collector 30 and the first separator 21.

In addition, as illustrated in FIG. 1, since the first separator 21 is formed to be larger than the positive electrode 10, it is possible to suppress a short circuit inside a battery due to mechanical deformation against external stress, and when a lithium metal layer is formed on the negative electrode current collector by charging, it is possible to block the excessive formation of the lithium metal layer up to the positive electrode.

A total thickness of the thin lithium battery according to one aspect of the present invention may be 100 to 2000 μm, more preferably 150 to 1500 μm, and still more preferably 200 to 1200 μm, but is not limited thereto, but it is possible to manufacture the thin lithium battery as a thin film as in the above range, and it is possible to provide a flexible battery.

Hereinafter, each configuration constituting the thin lithium battery of the first aspect of the present invention will be described in more detail.

<Upper Sheet 50>

In one aspect, the upper sheet 50 may be formed of a metal layer, and the positive electrode current collector 11 and the metal layer may be in close contact with each other to be electrically connected to each other. In this case, since the negative electrode current collector 30 also has a structure exposed to the outside, a separate tab or terminal unit may not be required.

Also, although not illustrated separately, in the first aspect, a separate tab or terminal unit may be further provided, and the metal layer of the upper sheet 50 may further include a terminal unit extending further in a plane direction than an outer end of the barrier rib 40. In this case, the terminal unit may be one in which the metal layer is further extended or a separate metal layer is further connected to the metal layer. In addition, the negative electrode current collector 30 may further include a terminal unit extending further in the plane direction than the outer end of the barrier rib 40. In this case, the terminal unit may be one in which the negative electrode current collector 30 is further extended or a separate metal layer is further connected to the negative electrode current collector 30.

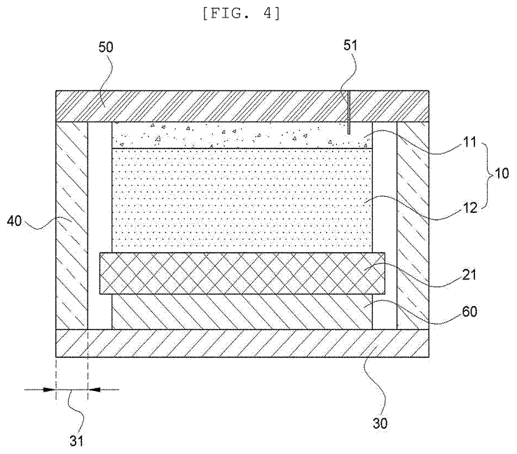

In another aspect, the upper sheet 50 is formed of the metal layer, and at least one joint may be provided in a portion in which the positive electrode current collector and the metal layer are in close contact with each other. This is illustrated in FIG. 4. That is, as illustrated in FIG. 4, in the first aspect, at least one joint 51 may be further provided in a portion where the positive electrode current collector and the metal layer are in close contact with each other. Since a contact resistance may be reduced by forming the joint, it is possible to further improve electrical performance, improve charging and discharging efficiency, and further improve output characteristics. The joint 51 may be formed in the portion where the metal layer of the upper sheet and the positive electrode current collector are in close contact with each other, and may be formed in only a portion or the entire portion, but may be formed in only a portion in terms of ease of manufacture. The joint 51 may be formed by welding, soldering, etc., but is not limited thereto. The welding may be formed in a spot or stripe shape by methods such as resistance welding, ultrasonic welding, and laser welding, but is not limited thereto. In addition, in the case of the soldering, the soldering paste may be further provided inside the upper sheet 50 formed of the metal layer, that is, on a portion in close contact with the electrode assembly.

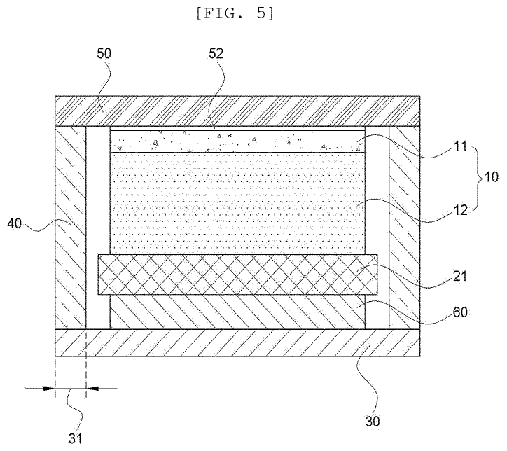

In another aspect, the upper sheet 50 is made of the metal layer, and the thin lithium battery may further include at least one conductive layer selected from a conductive adhesive layer, a conductive pressure-sensitive adhesive layer, a conductive paste layer, and an anisotropic conductive layer provided in the portion where the positive electrode current collector and the metal layer are in close contact with each other. This is illustrated in FIG. 5. The conductive adhesive layer, the conductive pressure-sensitive adhesive layer, the conductive paste layer, and the anisotropic conductive layer are not limited as long as they are commonly used in the field, and the metal layer of the upper sheet and the positive electrode current collector may be in better close contact with each other, so electricity can pass through better. In addition, although not illustrated, the upper sheet 50 may further include the joint 51 as illustrated in FIG. 4 if necessary.

In another aspect, the upper sheet 50 may further include an insulating layer (not illustrated) on an outer surface of the metal layer. Since the upper sheet may further include an insulating layer, it is possible to protect the electrode assembly from external materials on the outside of the metal layer, and to electrically insulate the electrode assembly from the outside. In this case, the insulating layer may include a groove in which the insulating layer is not formed as a part of the insulating layer is opened. The groove may be formed in the portion in close contact with the positive electrode current collector of the upper sheet 50, and may transmit electricity to the outside through the groove. In this case, the upper sheet 50 may further include a separate terminal, but may be configured without a separate terminal.

The insulating layer (not illustrated) may be used without limitation as long as it is a material having electrical insulating properties, and may be used without limitation as long as it may protect the electrode assembly from the external materials on the outside of the metal layer and electrically insulate the electrode assembly from the outside. Specifically, for example, polyethylene, polypropylene, casted polypropylene (CPP), polystyrene, polyethylene terephthalate, polyvinyl chloride, polyvinylidene chloride, polyamide, a cellulose resin, a polyimide resin, or the like may be used, but the present invention is not limited thereto. In addition, one layer or two or more layers may be stacked. In addition, although not illustrated, the upper sheet 50 may further include the joint 51 as illustrated in FIG. 4 if necessary.

In another aspect, the upper sheet 50 may be a laminate (not illustrated) including a barrier layer and a sealing layer. In addition, if necessary, a base layer may be further provided on the barrier layer. In addition, the opening may be formed in a portion of the upper sheet 50, so a portion of the positive electrode current collector may be exposed to the outside.

The barrier layer is to prevent penetration of water vapor, gas, etc., from the outside, and may be specifically made of, for example, a metal foil. In addition to the metal foil, it may be a sheet or a film made of a polymer resin having barrier properties. The metal foil may be made of any one selected from any one of an alloy of iron (Fe), carbon (C), chromium (Cr), and manganese (Mn), an alloy of iron (Fe), carbon (C), chromium (Cr), and nickel (Ni), aluminum (Al), copper (Cu), or an equivalent thereof, but the present invention is not limited thereto. The thickness of the barrier layer is not limited, but may be, for example, 0.1 to 100 μm, more specifically 0.5 to 50 μm, and more preferably 1 to 10 μm.

The sealing layer is an innermost layer of the upper sheet and is a layer that is in contact with the positive electrode current collector. In addition, the sealing layer serves to thermally fusing and sealing the battery during manufacturing. The sealing layer may be made of an insulating material, and may be made of a material that may be thermally fused and adhered to the current collector. More specifically, the sealing layer may be adhered in close contact with the current collector by heat compression. Therefore, the sealing is possible by heat compression, and any material having electrical insulation may be used without limitation. Specific examples thereof may include polyolefins, cyclic polyolefins, carboxylic acid-modified polyolefins, carboxylic acid-modified cyclic polyolefins, and the like.

Specific examples of the polyolefin may include polyethylenes such as low-density polyethylene, medium-density polyethylene, high-density polyethylene, and linear low-density polyethylene; polypropylenes such as homopolypropylene, a block copolymer (e.g., a block copolymer of propylene and ethylene) of polypropylene, and a random copolymer (e.g., a random copolymer of propylene and ethylene) of polypropylene; terpolymers of ethylene-butene-propylene, and the like.

The cyclic polyolefin is a copolymer of an olefin and a cyclic monomer, and examples of the olefin as a constituent monomer of the cyclic polyolefin may include ethylene, propylene, 4-methyl-1-pentene, styrene, butadiene, isoprene, and the like.

In addition, examples of a cyclic monomer which is a structural monomer of the cyclic polyolefin may include cyclic alkenes, such as norbornene, and specific examples thereof may include cyclic dienes, such as cyclopentadiene, dicyclopentadiene, cyclohexadiene and norbornadiene, and the like.

The carboxylic acid-modified polyolefin is a polymer modified by block polymerization or graft polymerization of the polyolefin with carboxylic acid. Examples of carboxylic acid used for modification may include maleic acid, acrylic acid, itaconic acid, crotonic acid, maleic anhydride, itaconic anhydride, and the like.

The carboxylic acid-modified cyclic polyolefin is a polymer obtained by copolymerizing a part of the monomer constituting the cyclic polyolefin in place of α,β-unsaturated carboxylic acid or anhydride thereof, or block-polymerizing or graft-polymerizing α,β-unsaturated carboxylic acid or anhydride thereof with respect to the cyclic polyolefin.

The sealing layer may be formed by 1 type of resin component alone, and may be formed by a blend polymer which 2 or more types of resin components are combined. In addition, it may be formed of only one layer, or may be formed of two or more layers by the same or different resin components.

The thickness of the sealing layer is not limited, but may be, for example, 1 to 100 μm, and more specifically, 1 to 50 μm.

The base layer is a layer forming the outermost layer of the upper sheet. If necessary, a printing layer and a hard coating layer for preventing scratches on the surface may be further formed on the surface constituting the outermost layer of the base layer.

The material forming the base layer may be used without limitation as long as it has insulation. Specifically, for example, a resin such as a polyolefin resin, a polyester resin, a polyamide resin, an epoxy resin, an acrylic resin, a fluororesin, a polyurethane resin, a phenol resin, and a mixture or copolymer thereof may be used.

The base layer may be prepared in the form of a film or sheet of the above-described resin, and more specifically, may be a uniaxially or biaxially stretched film.

The thickness of the base layer is not limited, and may be, for example, 1 to 300 μm, and more specifically 5 to 100 μm.

<Positive Electrode 10>

In the first aspect of the present invention, the positive electrode 10 may be a positive electrode-electrolyte conjugate in which a composite active material layer 12 in which a positive electrode active material layer including lithium complex oxide and a first gel polymer electrolyte are integrated on the positive electrode current collector 11 is formed. The positive electrode-electrolyte conjugate may be one obtained by applying a gel polymer electrolyte composition on the positive electrode active material layer and then gellating the gel polymer electrolyte composition. By the gelation, the mechanical strength and structural stability of the positive electrode-electrolyte conjugate may be improved, and the structural stability of the positive electrode interface may be improved.

The positive electrode current collector 11 is not limited as long as it is a substrate having excellent conductivity used in the relevant technical field, and may be made of one including any one selected from a conductive metal, a conductive metal oxide, and the like. In addition, the current collector may be of a type in which the entire substrate is made of a conductive material, or a conductive metal, a conductive metal oxide, a conductive polymer, etc., are coated on one or both surfaces of the insulating substrate. In addition, the current collector may be made of a flexible substrate, and may be easily bent to provide a flexible electronic device. In addition, it may be made of a material having a restoring force that returns to an original shape after bending. In addition, the current collector may be selected from the group consisting of a thin film type, a mesh type, an integrated type by stacking a thin film or mesh type current collector on one or both sides of a conductive substrate, and a metal-mesh composite. The metal-mesh composite is integrated with a thin film type metal and a mesh type metal or a polymer material by heat compression, and thus, the thin metal film is inserted between holes of the mesh and integrated, so it means that the metal thin film does not break or crack even when bent. As such, when the metal-mesh composite is used, it is more preferable to prevent cracks from occurring in the current collector during the bending of the battery or during the charging and discharging, but is not limited thereto. More specifically, for example, the current collector may be made of aluminum, stainless steel, copper, nickel, iron, lithium, cobalt, titanium, nickel foam, copper foam, a polymer substrate coated with a conductive metal, a composite thereof, and the like, but is not limited thereto.

In one aspect, the positive electrode current collector may be a laminate including a first positive electrode metal layer and a second positive electrode metal layer, and the first positive electrode metal layer and the second positive electrode metal layer may have different compositions.

The composite active material layer 12 may be one in which the positive electrode active material layer and the first gel polymer electrolyte are integrated, where the ‘integration’ means that the first gel polymer electrolyte is applied on the positive electrode active material layer and partially or completely impregnated into the active material layer, or the first gel polymer electrolyte layer is formed on the surface of the active material layer. In a specific aspect, after forming the positive electrode active material layer on the positive electrode current collector, the first gel polymer electrolyte composition may be applied on the positive electrode active material layer to be integrated.

The positive electrode active material layer may be formed by applying the positive electrode active material composition on the positive electrode current collector, or a positive electrode formed with a positive electrode active material layer may be manufactured by casting the positive electrode active material composition on a separate support, and then laminating the film obtained by peeling from the support on the positive electrode current collector. The thickness of the positive electrode active material layer is not limited, but may be 0.01 to 500 μm, more preferably 1 to 200 μm, but is not limited thereto.

The positive electrode active material composition is not limited, but may include a positive electrode active material, a binder, and a solvent, and may further include a conductive material.

The positive electrode active material may be used without limitation as long as it is commonly used in the art. Specifically, for a lithium primary battery or a secondary battery, for example, a compound (lithiated intercalation compound) capable of reversible intercalation and deintercalation of lithium may be used. The positive electrode active material of the present invention may be in the form of powder.

Specifically, at least one of a complex oxide of lithium and a metal consisting of any one or a combination of two or more selected from cobalt, manganese, nickel, etc., may be used. Although not limited, as a specific example, a compound represented by any one of the following formulas may be used. LiₐA_{1-b}R_{b}D₂ (in the above Formula, 0.90≤a≤1.8 and 0≤b≤0.5); LiₐE_{1-b}R_{b}O_{2-c}D_{c} (in the above Formula, 0.90≤a≤1.8, 0≤b≤0.5, and 0≤c≤0.05); LiE_{2-b}R_{b}O_{4-c}D_{c} (in the above Formula, 0≤b≤0.5, 0≤c≤0.05); LiₐNi_{1-b-c}Co_{b}R_{c}Dₐ (in the above Formula, 0.90≤a≤1.8, 0≤b≤0.5, 0≤c≤0.05 and 0≤a≤2); LiₐNi_{1-b-c}Co_{b}R_{c}O₂₋ₐZₐ (in the above Formula, 0.90≤a≤1.8, 0≤b≤0.5, 0≤c≤0.05 and 0≤a≤2); LiₐNi_{1-b-c}Co_{b}R_{c}O₂₋ₐZ₂ (in the above Formula, 0.90≤a≤1.8, 0≤b≤0.5, 0≤c≤0.05 and 0≤a≤2); LiₐNi_{1-b-c}Mn_{b}R_{c}Dₐ (in the above Formula, 0.90≤a≤1.8, 0≤b≤0.5, 0≤c≤0.05 and 0≤x≤2); LiₐNi_{1-b-c} Mn_{b}R_{c}O₂₋ₐZₐ (in the above Formula, 0.90≤a≤1.8, 0≤b≤0.5, 0≤c≤0.05 and 0≤a≤2); LiₐNi_{1-b-c}Mn_{b}R_{c}O₂₋ₐZ₂ (in the above Formula, 0.90≤a≤1.8, 0≤b≤0.5, 0≤c≤0.05 and 0≤a≤2); LiₐNi_{b}E_{c}G_{d}O₂ (in the above Formula, 0.90≤a≤1.8, 0≤b≤0.9, 0≤c≤0.5 and 0.001≤d≤0.1); LiₐNi_{b}Co_{c}Mn_{d}G_{c}O₂ (in the above Formula, 0.90≤a≤1.8≤b≤0.9≤c≤0.5, 0≤d≤0.5 and 0.001≤e≤0.1); LiₐNiG_{b}O₂ (in the above Formula, 0.90≤a≤1.8 and 0.001≤b≤0.1); LiₐCoG_{b}O₂ (in the above Formula, 0.90≤a≤1.8 and 0.001≤b≤0.1); LiₐMnG_{b}O₂ (in the above Formula, 0.90≤a≤1.8 and 0.001≤b≤0.1); LiₐMn₂G_{b}O₄ (in the above Formula, 0.90≤a≤1.8 and 0.001≤b≤0.1); QO₂; QS₂; LiQS₂; V₂O₅; LiV₂O₅; LiTO₂; LiNiVO₄; Li_{(3-f)}J₂(PO₄)₃(0≤f≤2); Li_{(3-f)}. Fe₂(PO₄)₃ (0≤f≤2); and LiFePO₄.

In the above formula, A is Ni, Co, Mn, or a combination thereof, R is Al, Ni, Co, Mn, Cr, Fe, Mg, Sr, V, a rare earth element, or a combination thereof, D is O, F, S, P or a combination thereof, E is Co, Mn, or a combination thereof, Z is F, S, P or a combination thereof, G is Al, Cr, Mn, Fe, Mg, La, Ce, Sr, V or a combination thereof, Q is Ti, Mo, Mn or a combination thereof, T is Cr, V, Fe, Sc, Y or a combination thereof, J is V, Cr, Mn, Co, Ni, Cu, or a combination thereof.

Of course, a compound having a coating layer on the surface of the compound may be used, or a mixture of the compound and a compound having a coating layer may be used. The coating layer may include, as a coating element compound, oxide of a coating element, hydroxide, oxyhydroxide of a coating element, oxycarbonate of a coating element, or hydroxycarbonate of a coating element. The compound constituting these coating layers may be amorphous or crystalline. As the coating element included in the coating layer, Mg, Al, Co, K, Na, Ca, Si, Ti, V, Sn, Ge, Ga, B, As, Zr, or a mixture thereof may be used. In the coating layer forming process, any coating method may be used as long as it may be coated by a method that does not adversely affect the physical properties of the positive electrode active material by using these elements in the compound, for example, a spray coating method, a dipping method, etc. Since it is a content that may be well understood by those engaged in the field, a detailed description thereof will be omitted.

The positive electrode active material may include 20 to 99% by weight, more preferably 30 to 95% by weight of the total weight of the composition. In addition, an average particle diameter may be 0.001 to 50 μm, more preferably 0.01 to 20 μM, but is not limited thereto.

The binder well adheres the positive electrode active material particles to each other, and also serves to fix the positive electrode active material to the current collector. Any binder may be used without limitation as long as it is conventionally used in the relevant field, and representative examples of the binder may include polyvinyl alcohol, carboxymethyl cellulose, hydroxypropyl cellulose, polyvinyl chloride, carboxylated polyvinyl chloride, polyvinyl fluoride, polymers including ethylene oxide, polyvinylpyrrolidone, polyurethane, polytetra fluoroethylene, polyvinylidene fluoride, polyethylene, polypropylene, styrene-butadiene rubber, acrylated styrene-butadiene rubber, epoxy resin, nylon, etc., alone or in combination of two or more, but is not limited thereto. Although not limited, the content of the binder may be 0.1 to 20% by weight, and more preferably 1 to 10% by weight based on the total weight. The above range is an amount sufficient to act as a binder, but is not limited thereto.

The solvent may be any one or a mixed solvent of two or more selected from N-methyl pyrrolidone, acetone, and water, and is not limited thereto, and may be used as long as it is commonly used in the art. The content of the solvent is not limited, and it may be used without limitation as long as it may be applied on the positive electrode current collector in a slurry state.

In addition, the positive electrode active material composition may further include a conductive material.

The conductive material is used to impart conductivity to the electrode, and may be used without limitation as long as it does not cause a chemical change in the configured battery and is a conductive material. Specifically, a conductive material including carbon-based materials such as natural graphite, artificial graphite, carbon black, acetylene black, ketjen black, carbon nanotubes, and carbon fibers; metal-based materials such as metal powders such as copper, nickel, aluminum, and silver, or metal fibers; conductive polymers such as polyphenylene derivatives; or a mixture thereof may be used, and a conductive material in which the above materials are used alone or two or more of the above materials are mixed may be used.

The content of the conductive material may include 0.1 to 20% by weight, specifically 0.5 to 10% by weight, and more specifically 1 to 5% by weight of the positive electrode active material composition, but is not limited thereto. In addition, the average particle diameter of the conductive material may be 0.001 to 1000 Om, and more specifically 0.01 to 100 Om, but is not limited thereto.

The first gel polymer electrolyte includes a solvent and a dissociable salt, and includes a polymer matrix including any one or two or more selected from the group consisting of a linear polymer and a crosslinked polymer.

The linear polymer may be gelled and integrated by a gelation process after application, and the crosslinked polymer may be cured and integrated by a crosslinking process after application. When both the linear polymer and the crosslinked polymer are used, they are gelled and cured by a gelation process and a crosslinking process after application to form a polymer matrix of a semi-interpenetrating network (semi-IPN) structure and may be integrated. For this, each aspect will be described as follows.

First, in one aspect of the first gel polymer electrolyte, in the case of a crosslinked polymer matrix, any one or two or more monomers selected from the group consisting of crosslinkable monomers and derivatives thereof, an initiator, and a gel polymer electrolyte composition containing a liquid electrolyte may be applied on the positive electrode, and the liquid electrolyte and the like may be uniformly distributed in the polymer matrix in the form of a net by crosslinking by applying ultraviolet radiation or heat, so the evaporation process of the solvent may be unnecessary.

The gel polymer electrolyte made of the crosslinked polymer matrix may be one in which a liquid electrolyte, a crosslinkable monomer, and a derivative thereof are optically crosslinked or thermally crosslinked by an initiator to form a crosslinked polymer matrix. By the crosslinking, the mechanical strength and structural stability of the gel polymer electrolyte layer are improved, and when combined with the positive electrode of the above-described embodiment, the structural stability of the interface between the gel polymer electrolyte layer and the positive electrode may be further improved.

The first gel polymer electrolyte composition preferably has a viscosity suitable for the coating process, and specifically, for example, a viscosity measured using a Brookfield viscometer at 25° C. is 0.1 to 10,000,000 cps, preferably 1.0 to 1,000,000 cps, and more preferably, 1.0 to 100,000 cps, and since the above viscosity is a viscosity suitable for application to a coating process in the above range, it is preferable, but is not limited thereto.

The first gel polymer electrolyte composition may include 1 to 50% by weight of a crosslinkable monomer, and specifically 2 to 40% by weight based on 100% by weight of the total composition, but is not limited thereto. The initiator may be included in an amount of 0.01 to 50% by weight, specifically 0.01 to 20% by weight, and more specifically 0.1 to 10% by weight, but is not limited thereto. The liquid electrolyte may be included in an amount of 1 to 95% by weight, specifically 1 to 90% by weight, and more specifically 2 to 80% by weight, but is not limited thereto.

As the crosslinkable monomer, a monomer having two or more functional groups or a mixture of a monomer having two or more functional groups and a monomer having one functional group may be used, and any monomer capable of photocrosslinking or thermal crosslinking may be used without limitation.

Specific example of the monomer having two or more functional groups may include any one or a mixture of two or more selected from ethylene glycol diacrylate, ethylene glycol dimethacrylate, triethylene glycol diacrylate, triethylene glycol dimethacrylate, trimethylolpropane ethoxylate triacrylate, trimethylolpropane ethoxylate trimethacrylate, bisphenol ethoxylate diacrylate, bisphenol aethoxylate dimethacrylate, and the like.

In addition, the monomer having one functional group may be any one or a mixture of two or more selected from methyl methacrylate, ethyl methacrylate, butyl methacrylate, methyl acrylate, butyl acrylate, ethylene glycol methyl ether acrylate, ethylene glycol methyl ether methacrylate, acrylonitrile, vinyl acetate, vinyl chloride, vinyl fluoride, and the like.

In addition, the initiator may be used for the photocrosslinking or thermal crosslinking of the monomer. As the initiator, any photoinitiator or thermal initiator commonly used in the art may be used without limitation.

The liquid electrolyte may include a dissociable salt and a solvent.

The dissociable salt is not limited, but specifically, for example, may be any one or a mixture of two or more selected from lithium hexafluorophosphate (LiPF₆), lithium tetrafluoroborate (LiBF₄), lithium hexafluoroantimonate (LiSbF₆), lithium hexafluoroacetate (LiAsF₆), lithium difluoromethanesulfonate (LiC₄F₉SO₃), lithium perchlorate (LiClO₄), lithium aluminate (LiAlO₂), lithium tetrachloroaluminate (LiAlCl₄), lithium chloride (LiCl), lithium iodide (LiI), lithium bisoxalatoborate (LiB(C₂O₄)₂), lithium difluorooxalatoborate (LiB(C₂O₄)F₂), lithium bisfluorosulfonylimide (LiFSI), lithium trifluoromethanesulfonylimide (LiN(CₓF₂ₓ₊₁SO₂)(C_{y}F_{2y+1}SO₂) (where x and y are natural numbers), and derivatives thereof. The concentration of the dissociable salt is 0.1 to 10.0 M, and more specifically, 1 to 5 M, but is not limited thereto.

As the solvent, any one or two or more mixed solvents selected from organic solvents such as carbonate-based solvents, nitrile-based solvents, ester-based solvents, ether-based solvents, ketone-based solvents, glyme-based solvents, alcohol-based solvents, propionate-based solvents, and aprotic solvents and water may be used.

Another aspect of the first gel polymer electrolyte may be a semi-interpenetrating network (semi-IPN) structure by further including a linear polymer in a crosslinked polymer matrix. In this case, the positive electrode-electrolyte conjugate may further improve the mechanical strength and structural stability, and further improve the structural stability of the positive electrode interface.

The linear polymer may be used without limitation as long as it is a polymer that may impregnate a solvent. Specifically, the linear polymer may be, for example, any one or a combination of two or more selected from poly(vinylidene fluoride) (PVdF), poly (vinylidene fluoride)-co-hexafluoropropylene (PVdF-co-HFP), polymethylmethacrylate (PMMA), polystyrene (PS), polyvinyl acetate (PVA), polyacrylonitrile (PAN), and polyethylene oxide (PEO), and the like, but is not necessarily limited thereto.

The linear polymer may be included in an amount of 1 to 90 wt % based on the weight of the crosslinked polymer matrix. Specifically, the linear polymer may be included in an amount of 1 to 80% by weight, 1 to 70% by weight, 1 to 60% by weight, 1 to 50% by weight, 1 to 40% by weight, and 1 to 30% by weight. That is, when the polymer matrix has a semi-IPN structure, the crosslinkable polymer and the linear polymer may be included in a weight ratio of 99:1 to 10:90. When the linear polymer is included in the above range, the crosslinked polymer matrix may secure flexibility while maintaining appropriate mechanical strength. Accordingly, when applied to a flexible battery, it is possible to implement stable battery performance even when the shape is deformed by various external forces, and it is possible to suppress the risk of battery ignition and explosion or the like that may be caused by the shape deformation of the battery.

Another aspect of the first gel polymer electrolyte may be formed of a linear polymer matrix gelled by applying and gelling a gel polymer electrolyte composition including a linear polymer and a liquid electrolyte. Specifically, for example, the first gel polymer electrolyte may be one obtained by applying a gel polymer electrolyte composition including a linear polymer, a solvent, and a dissociable salt on a positive electrode active material layer, and physically crosslinking and gellating the gel polymer electrolyte composition. By the gelation, the mechanical strength and structural stability of the positive electrode-electrolyte conjugate may be improved, and the structural stability of the positive electrode interface may be improved. In this case, since the linear polymer and the liquid electrolyte are the same as described above, redundant descriptions will be omitted. In one aspect, based on the total 100% by weight of the composition including the linear polymer, the salt, the solvent, and the like, the linear polymer may be included in 1 to 50% by weight, and preferably 1 to 30% by weight, but is not limited thereto. In addition, the solvent may be included in an amount of 1 to 99% by weight, preferably 8 to 60% by weight, and more preferably 10 to 50% by weight, but is not limited thereto. The concentration of the dissociable salt is 0.1 to 10.0 M, and more specifically, 1 to 5 M, but is not limited thereto.

In addition, the first gel polymer electrolyte composition may further include inorganic particles if necessary. The inorganic particles may be coated by controlling rheological properties such as the viscosity of the gel polymer electrolyte composition. The inorganic particles may be used to improve the ionic conductivity of the electrolyte and to improve the mechanical strength, and may be porous particles, but is not limited thereto. For example, metal oxides, carbon oxides, carbon-based materials, organic-inorganic composites, and the like may be used alone or in combination of two or more. More specifically, any one or a mixture of two or more selected from, for example, SiO₂, Al₂O₃, TiO₂, BaTiO₃, Li₂O, LiF, LiOH, Li₃N, BaO, Na₂O, Li₂CO₃, CaCO₃, LiAlO₂, SrTiO₃, SnO₂, CeO₂, MgO, NiO, CaO, ZnO, ZrO₂, SiC, and the like may be used. Although not limited, by using the inorganic particles, it is possible to improve the thermal stability of the electrochemical device because it has high affinity with the organic solvent and is also very thermally stable.

The average diameter of the inorganic particles is not limited, but may be 0.001 μm to 10 μm. Specifically, it may be 0.1 to 10 μm, and more specifically 0.1 to 5 μm. When the average diameter of the inorganic particles satisfies the above range, the excellent mechanical strength and stability of the electrochemical device may be realized.

The content of the inorganic particles in the first gel polymer electrolyte composition may be 0.1 to 50% by weight, specifically 0.5 to 40% by weight, and more specifically 1 to 30% by weight, and may be used in an amount that satisfies the above-described viscosity range of 0.1 to 10,000,000 cps, more preferably 1.0 to 1,000,000 cps, and more preferably 1.0 to 100,000 cps, but is not limited thereto.

In addition, the first gel polymer electrolyte composition may further include a performance enhancing agent if necessary. Non-limiting examples of the performance enhancing agent include any one or a mixture of two or more selected from the group consisting of a high voltage stability enhancing agent, a high temperature stability enhancing agent, an electrolyte wettability enhancing agent, an interfacial stabilizer, a gas generation inhibitor, an electrode adhesion enhancing agent, an anion stabilizer, and the like.

Non-limiting examples of the high voltage stability enhancing agent may include any one or a mixture of two or more selected from prop-1-ene-1,3-sultone, propane sultone, butane sultone, ethylene sulfate, ethylene propylene sulfate, trimethylene sulfate, vinyl sulfone, methyl sulfone, phenyl sulfone, benzyl sulfone, tetramethylene sulfone, butadiene sulfone, benzoyl peroxide, lauroyl peroxide, 2-methyl maleic anhydride, succinonitrile, glutarnitrile, adiponitrile, pimelonitrile, suberonitrile, sebaconitrile, azaleic dinitrile, butylamine, N,N-dicyclohexylcarbodiamine, N,N-dimethyl amino trimethyl silane, N,N-dimethylacetamide, sulfolane, propylene carbonate, and the like.

Non-limiting examples of the high temperature stability enhancing agent may include any one or a mixture of two or more selected from propane sultone, propene sultone, dimethyl sulfone, diphenyl sulfone, divinyl sulfone, methane sulfonic acid, propylene sulfone, 3-fluorotoluene, 2,5-dichlorotoluene, 2-fluorobiphenyl, dicyanobutene, tris(-trimethyl-silyl)-phosphite, vinyl ethylene carbonate, 1,3,6-hexane-tri-cyanide, 1,2,6-hexane-tri-cyanide, pyridine, 4-ethyl pyridine, 4-acetyl pyridine, 3-cyano pyridine, and the like.

Non-limiting examples of the electrolyte wettability enhancing agent may include any one or a mixture of two or more selected from lithium bis (fluorosulfonyl) imide, lithium bis (trifluoromethylsulfonyl) imide, maleic acid, tannic acid, silicon oxide, aluminum oxide, zirconia oxide, titanium oxide, zinc oxide, manganese oxide, magnesium oxide, calcium oxide, iron oxide, barium oxide, molybdenum oxide, ruthenium oxide, zeolite, and the like.

Non-limiting examples of the interface stabilizer may include any one or a mixture of two or more selected from vinylene carbonate, vinyl ethylene carbonate, methylene ethylene carbonate, methylenemethylethylene carbonate, fluoroethylene carbonate, allyltrimethoxysilane, allyltriethoxysilane, cyclohexyltrimethoxysilane, phenyltrimethoxysilane, phenyltriethoxysilane, vinyltrimethoxysilane, vinyl triethoxysilane, 3-methacryloxypropyltrimethoxysilane, 3-mercaptopropyltrimethoxysilane, 3-glycidoxypropyltrimethoxysilane, 3-glycidoxypropyltriethoxysilane, 3-glycidoxypropylethoxydimethylsilane, ethylene glycol diglycidyl ether, diethylene glycol diglycidyl ether, polyethylene glycol diglycidyl ether, propylene glycol diglycidyl ether, tripropylene glycol diglycidyl ether, polypropylene glycol diglycidyl ether, allyl glycidyl ether, phenyl glycidyl ether, fluoro γ-butyrolactone, difluoro γ-butyrolactone, chloro γ-butyrolactone, dichloro-butyrolactone, bromo γ-butyrolactone, dibromo γ-butyrolactone, nitro γ-butyrolactone, cyano γ-butyrolactone, molybdenum sulfide, and the like.

Non-limiting examples of the gas generation inhibitor may include any one or a mixture of two or more selected from diphenyl sulfone, divinyl sulfone, vinyl sulfone, phenyl sulfone, benzyl sulfone, tetramethylene sulfone, butadiene sulfone, diethylene glycol diacrylate, diethylene glycol dimethacrylate, ethylene glycol dimethacrylate, dipropylene glycol diacrylate, dipropylene glycol dimethacrylate, ethylene glycol divinyl ether, ethoxylated trimethylolpropane triacrylate, diethylene glycol divinyl ether, triethylene glycol dimethacrylate, difetaerythritol pentaacrylate, trimethylolpropane triacrylate, trimethylolpropane trimethacrylate, propoxylated (3) trimethylolpropane triacrylate, propoxylated (6) trimethylolpropane triacrylate, polyethylene glycol diacrylate, and the like.

Non-limiting examples of the electrode adhesion enhancing agent may include any one or a mixture of two or more selected from acetonitrile, thiopheneacetonitrile, methoxyphenylacetonitrile, fluorophenylacetonitrile, acrylonitrile, methoxyacrylonitrile, ethoxyacrylonitrile, and the like.

Non-limiting examples of the anion stabilizer may include any one or a mixture of two or more selected from dimethyl sulfone, sulfolane, benzimidazole, and the like.

<First Separator 21>

In the first aspect of the present invention, the first separator 21 may have a gel polymer electrolyte integrated therein to further improve ionic conductivity.

The first separator 21 may be used without limitation as long as it is generally used in an electrochemical device. Specifically, it may be used without limitation as long as it has electrical insulation properties, and at the same time, electrolyte uptake is possible. For example, it may be a porous membrane, a non-porous membrane, or the like such as a woven fabric or a non-woven fabric, and may be a multilayer membrane in which one layer or two or more layers are stacked. The material of the separator is not limited, but specifically, examples of the materials may include any one or a mixture of two or more selected from the group consisting of polyethylene, polypropylene, polybutylene, polypentene, polymethylpentene, polyethylene terephthalate, polybutylene terephthalate, polyacetal, polyamide, polycarbonate, polyimide, polyether sulfone, polyphenylene oxide, polyphenylene sulfide, polyethylene naphthalene, polyvinylidene fluoride, polyvinylidene fluoride hexafluoropropylene, polymethyl methacrylate, polystyrene, polyvinyl acetate, polyacrylonitrile, polyethylene oxide, and copolymers thereof. In addition, the thickness is not limited, and may be in the range of 1 to 1000 μm, and more specifically 10 to 800 μm, which is typically used in the art, but is not limited thereto.

Also, the first separator 21 may be impregnated or swollen with a gel polymer electrolyte (second gel polymer electrolyte). More specifically, the first separator 21 may include an electrolyte obtained by applying a second gel polymer electrolyte composition to a porous membrane such as the woven fabric or non-woven fabric, and curing and/or gellating the composition. Alternatively, the first separator 21 may include an electrolyte obtained by introducing the electrolyte into the polymer chain of the non-porous membrane through a swelling phenomenon by applying the second gel polymer electrolyte composition to the non-porous membrane, and gelling and/or curing the composition. Alternatively, the first separator 21 may be a composite by adding a separator material (material) to the second gel polymer electrolyte composition, casting the composition in a membrane form, and curing and/or gellating the composition. Therefore, the separator-electrolyte conjugate may be a structure (porous separator-electrolyte conjugate) in which the pores of the separator material are filled with the second gel polymer electrolyte or a dense membrane structure (non-porous separator-electrolyte conjugate) in which the separator material and the second gel polymer electrolyte are complexed at a molecular scale. The separator may be used in the form of the separator-electrolyte conjugate from the viewpoint of improving mechanical strength, and may be used to further improve ionic conductivity. In this case, the application may be performed using not only a coating method such as bar coating, spin coating, slot die coating, and dip coating, but also an injection method.

Since the second gel polymer electrolyte and the second gel polymer electrolyte composition are the same as those described above in the first gel polymer electrolyte and the first gel polymer electrolyte composition, redundant descriptions will be omitted. In this case, the second gel polymer electrolyte (second gel polymer electrolyte composition) may be the same as or different from the first gel polymer electrolyte (first gel polymer electrolyte composition) used in the positive electrode.

The first gel polymer electrolyte and the second gel polymer electrolyte may include a solvent and a dissociable salt, and may be formed of a polymer matrix further including any one or two or more selected from the group consisting of linear polymers and crosslinked polymers. In addition, if necessary, it may further include a performance enhancing agent. Thus, “different” means that they may be made of different compositions. Specifically, the first gel polymer electrolyte and the second gel polymer electrolyte may be different in at least one of a type of solvent; a type or concentration of dissociable salt; a type or content of linear polymer; a type or content of crosslinked polymer; and a type or concentration of performance enhancing agent.

More specifically, the ionic conductivity IC₁ of the first gel polymer electrolyte and the ionic conductivity IC₂ of the second gel polymer electrolyte may satisfy Equation 1 below.

IC₂−IC₂≥0.1 mS/cm [Equation 1]

When the difference in the ionic conductivity is 0.1 mS/cm or more, charging/discharging efficiency and battery life are increased, and at the same time, high battery safety may be secured.

In one aspect, the first and second gel polymer electrolyte compositions may have different ionic conductivity.

In one embodiment, the first and second gel polymer electrolyte compositions may have a difference in ionic conductivity of 0.1 mS/cm or more. The upper limit is not limited, but specifically, for example, may be 0.1 to 100 mS/cm.

The ionic conductivity may be calculated as follows.

IC₁=(τ_{cathode}²×IC_{cathode})/P_{cathode} [Calculation Equation 1]

IC₂=(τ_{porous separator}²×IC_{porous separator})/P_{porous separator} [Calculation Equation 2]

or,

IC₂=(τ_{dense separator}²×IC_{dense separator})/U_{dense separator}

In this case, IC₁ is the ionic conductivity of the first gel polymer electrolyte, IC₂ is the ionic conductivity of the second gel polymer electrolyte, and IC_{cathode}, IC_{porous separator}, and IC_{dense separator} are the ionic conductivity of the positive electrode-electrolyte conjugate, the porous separator-electrolyte conjugate, and the non-porous-electrolyte conjugate, respectively, τ_{cathode}, τ_{porous separator}, and τ_{dense separator} are the curvature of the positive electrode, the porous separator, and the non-porous separator, respectively, P_{cathode} and P_{porous separator} are the porosity of the positive electrode and porous separator, and U_{dense separator} is the volume ratio of the gel polymer electrolyte in the non-porous separator-electrolyte conjugate.

In order to calculate the ionic conductivity of the electrolyte, the porosity (% by volume) of the sample may be measured using a mercury pressure porosimeter for each of the positive electrode, the negative electrode, and the separator. In addition, in the case of the non-porous separator-electrolyte conjugate, % by volume of the electrolyte in the separator-electrolyte conjugate may be measured by measuring the uptake (% by volume) with respect to the standard electrolyte, which will be described later. The ionic conductivity of the positive electrode-electrolyte conjugate, the negative electrode-electrolyte conjugate, and the separator-electrolyte conjugate may be measured using a standard electrolyte with the known ionic conductivity (in this patent, a liquid electrolyte in which 1 mol of LiPF₆ is dissolved in a solvent mixed with 50% by volume of ethylene carbonate and 50% by volume of ethyl methyl carbonate as a standard electrolyte was used), and the curvature of the positive electrode, the negative electrode, and the separator may be calculated through the above calculation equation.

The ionic conductivity may be measured by cutting the positive electrode-electrolyte conjugate, the negative electrode-electrolyte conjugate, and the separator-electrolyte conjugate into a circle with a diameter of 18 mm and preparing a coin cell 2032, respectively, and then using an AC impedance measurement method depending on the temperature. The ionic conductivity was measured in a frequency band of 1 MHz to 0.01 Hz using a VMP3 measuring device.

In the case of the electrochemical device containing any electrolyte, the seal was removed, the positive electrode-electrolyte conjugate, the negative electrode-electrolyte conjugate, and the separator-electrolyte conjugate were separated, each conjugate was put in a dimethyl carbonate solvent and stored for 24 hours, put in an acetone solvent and stored for 24 hours, and then put in a dimethyl carbonate solvent again and stored for 24 hours, and the electrolyte in each conjugate was removed, and then dried in a vacuum atmosphere for 24 hours (in this case, the positive electrode and negative electrode from which the electrolyte was removed were 1300, and the separator was dried 60° C.). The curvature of the positive electrode, the negative electrode, and the separator from which the electrolyte has been removed may be calculated by using the porosity and standard electrolyte by the above-mentioned method, and the ionic conductivity of the positive electrode-electrolyte conjugate, the negative electrode-electrolyte conjugate, and the separator-electrolyte conjugate in the state before removing the electrolyte may be measured, and the ionic conductivity of the first electrolyte and the second electrolyte may be measured by the above calculation equation.

Hereinafter, the Nyquist plot for measuring the ionic conductivity of the positive electrode-electrolyte conjugate, the negative electrode-electrolyte conjugate, and the separator-electrolyte conjugate will be described in detail. The positive electrode-electrolyte conjugate and the negative electrode-electrolyte conjugate are composite conductors, and are electron conductors and ion conductors, and the Nyquist plot for these conjugates shows a shape of a semicircle. In this case, the semi-circle is divided into a resistance R₁ in a high frequency region and a resistance R₂ in a low frequency region, and the resistance to the ion conduction may be calculated using the following calculation equation.

Rᵢₒₙ=R₂−R₁ [Calculation Equation 4]

The separator-electrolyte conjugate is an ion conductor and shows a shape that rises vertically on the Nyquist plot, and the impedance resistance value of the horizontal axis means the resistance to the ion conduction. The ionic conductivity of the positive electrode-electrolyte conjugate, the negative electrode-electrolyte conjugate, and the separator-electrolyte conjugate is the resistance to the ion conduction obtained above, and may be calculated through the following calculation equation.

IC=L/(Rᵢₒₙ×A) [Calculation Equation 5]

In this case, L is the thickness of the sample (thickness excluding the current collector of the positive electrode and negative electrode and the thickness of the separator), and A is the area of the sample.

In one aspect, the first and second gel polymer electrolyte compositions may have a temperature at 20 to 80° C. and different slopes obtained from the Arrhenius plot of the ionic conductivity.

In the present invention, the slope of the Arrhenius plot may be obtained from the slope of the straight line at 20 to 80° C., with a graph showing the ionic conductivity data for each temperature obtained above on the horizontal axis, a reciprocal 1/T of the temperature T(K) and a logarithm of ionic conductivity ln(IC) on the vertical axis.

In the present invention, at least one of the differences of the type of solvent of the first gel polymer electrolyte and the second gel polymer electrolyte; the type or concentration of dissociable salt; the type or content of linear polymer; the type or content of crosslinked polymer; the type or concentration of performance enhancing agent may be confirmed by methods such as infrared spectroscopy, X-ray photoelectron analysis, inductively coupled plasma mass spectrometry, nuclear magnetic resonance spectroscopy, and time-of-flight secondary ion mass spectrometry.

More specifically, Fourier transform infrared spectroscopy (equipment name: 670-IR, equipment manufacturer: Varian) is separately performed on the positive electrode, the negative electrode, and the separator from the electrode assembly in the state where the charging/discharging current is applied and the initial formation process is completed. From the absorption spectrum obtained by spectroscopy of the reflected light when irradiated with infrared rays, the peak intensity derived from the material characteristics of different solvent types, salt types, and salt concentrations may be distinguished and determined.

X-ray photoelectron analysis (equipment name: K-Alpha, equipment Manufacturer: Thermo Fisher) was performed on the positive electrode, the negative electrode, and the separator by separating the positive electrode, the negative electrode, and the separator from the electrode assembly in the state where the charging/discharging current is applied and the initial formation process is completed. From the energy of photoelectrons escaped by X-rays irradiated to the sample, the presence or absence of elements contained in different solvents and salts and the state of chemical bonding may be distinguished and determined.

Inductively coupled plasma mass spectrometry (equipment name: ELAN DRC-II, equipment manufacturer: Perkin Elmer) was performed on the positive electrode, the negative electrode, and the separator by separating the positive electrode, the negative electrode, and the separator from the electrode assembly in the state where the charging/discharging current is applied and the initial formation process is completed. By ionizing the salt contained in the sample and separating the ions using the mass spectrometer, different types of solvents, types of salts, and concentrations of salts may be distinguished and determined.

Two-dimensional nuclear magnetic resonance spectroscopy (equipment name: AVANCE III, equipment manufacturer: Bruker) was performed on the positive electrode, the negative electrode, and the separator by separating the positive electrode, the negative electrode, and the separator from the electrode assembly in the state where the charging/discharging current is applied and the initial formation process is completed. By using the nuclear magnetic resonance phenomenon of atomic nuclei, which occurs when a magnetic field is applied to the performance enhancing agent included in the sample, different types of solvents, types of salts, and concentrations of salts may be distinguished and determined based on information on the chemical environment around the nucleus and spin bonds with neighboring atoms.

Time-of-flight mass spectrometry (equipment name: TOF-SIMS 5, equipment manufacturer: ION TOF) was performed on the positive electrode, the negative electrode, and the separator by separating the positive electrode, the negative electrode, and the separator from the electrode assembly in a state in which the charging/discharging current is applied and the initial formation process is completed. Through mass spectrometry of secondary ions generated in the sample, different types of solvents, types of salts, and concentrations of salts may be distinguished and determined.

<Negative Electrode Current Collector 30>

In the first aspect of the present invention, the negative electrode current collector 30 is formed only of a current collector. Accordingly, it is possible to provide a flexible battery while minimizing the thickness of the battery.

The negative electrode current collector 30 may be selected from the group consisting of a thin film type, an integrated type by stacking a thin film or mesh type current collector on one or both sides of a conductive substrate, and a metal-mesh composite. The metal-mesh composite is integrated with a thin film type metal and a mesh type metal or a polymer material by heat compression, and thus, the thin metal film is inserted between holes of the mesh and integrated, so it means that the metal does not break or crack even when bent. As such, when the metal-mesh composite is used, it is more preferable to prevent cracks from occurring in the current collector during the bending of the battery or during the charging and discharging, but is not limited thereto. The material may be made of metals or polymers such as lithium metal, aluminum, aluminum alloy, tin, tin alloy, zinc, zinc alloy, lithium aluminum alloy and other lithium metal alloy, a composite thereof, and the like.

The negative electrode current collector 30 may be used without limitation as long as it is a substrate having excellent conductivity used in the art. Specifically, for example, it may be made of one including any one selected from a conductive metal, a conductive metal oxide, and the like. In addition, the current collector may be of a type in which the entire substrate is made of a conductive material, or a conductive metal, a conductive metal oxide, a conductive polymer, etc., are coated on one or both surfaces of the insulating substrate. In addition, the current collector may be made of a flexible substrate, and may be easily bent to provide a flexible electronic device. In addition, it may be made of a material having a restoring force that returns to an original shape after bending. More specifically, for example, the current collector may be made of aluminum, zinc, silver, tin, tin oxide, stainless steel, copper, nickel, iron, lithium, cobalt, titanium, nickel foam, copper foam, a polymer substrate coated with a conductive metal, a composite thereof, and the like, but is not limited thereto. More preferably, it may be any one or a combination of two or more selected from the group consisting of aluminum, stainless steel, copper, nickel, and titanium.

In one aspect, the negative electrode current collector may be a laminate including a first negative electrode metal layer and a second negative electrode metal layer, the first negative electrode metal layer may be any one or a combination of two or more selected from the group consisting of copper, nickel, and stainless steel, the second negative electrode metal layer may be any one or a combination of two or more selected from the group consisting of aluminum, stainless steel, copper, nickel, and titanium, and the first negative electrode metal layer and the second negative electrode metal layer may have different compositions.

The thickness of the negative electrode current collector 30 may be 1 to 500 μm, and more specifically, 1 to 200 μm, but is not limited thereto.

In addition, although not illustrated, the negative electrode current collector may further include a terminal unit extending further than an outer end of the barrier rib. As described above in the description of the upper sheet, the negative electrode current collector 30 may further include a terminal unit extending further in a plane direction than the outer end of the barrier rib 40. In this case, the terminal unit may be one in which the negative electrode current collector 30 is further extended or a separate metal layer is further connected to the negative electrode current collector 30.

<Barrier Rib 40>

In the first aspect of the present invention, the shape of the barrier rib 40 is not limited, and the shape of the battery may be determined according to the external shape of the barrier rib. That is, when the shape of the outside of the barrier rib is circular, the shape of the negative electrode current collector and the upper sheet may also be circular. In addition, the shape of the separator and the positive electrode may be determined according to the shape of the inside of the barrier rib. That is, when the inside of the barrier rib is circular, the shape of the positive electrode and current collector housed may also be circular. In addition, the shape of the outside of the barrier rib may be quadrangular, but the shape inside the barrier rib may be circular. That is, the shape of the negative electrode current collector and the upper sheet may be quadrangular, and the shape of the positive electrode and the separator may be circular.

The barrier rib 40 may be made of a polymer material that may be fused and sealed by heat. The barrier rib may be melt-sealed by heat compressing using a heating plate, a heating roller, or the like. Since the material of the barrier rib is the same as that described for the sealing layer of the upper sheet, further description will be omitted.

In addition, the positive electrode and the separator may be housed in a space formed by sealing the negative electrode current collector and the upper sheet by the barrier rib.

Also, in one aspect of the present invention, the position where the barrier rib is formed is formed on an upper circumferential portion 31 of the upper surface of the negative electrode current collector. In addition, it may be formed to be spaced apart by a certain distance from the edge of the positive electrode 10, but is not limited specifically, and may be formed, for example, within 0.1 to 2 mm from the edge of the positive electrode, and more preferably, at a portion spaced apart by 0.5 to 1 mm. By having such a spaced distance, a space portion may be formed between the positive electrode and the barrier rib. In addition, it may be advantageous to provide a flexible battery by having such a spaced distance.

The thickness of the barrier rib is not limited, but may be 10 to 500 μm, preferably 20 to 400 μm, and more preferably 40 to 300 μm.

In addition to the barrier rib, it may further include an adhesive layer for more firmly bonding the upper sheet and the negative electrode current collector, if necessary. The adhesive layer may be used without limitation as long as it is conventionally used in the relevant field. Specifically, for example, an acrylic adhesive, an epoxy adhesive, a cellulose adhesive, etc., may be used, but the present invention is not limited thereto. The thickness of the adhesive layer may be specifically, for example, 0.1 to 100 μm, and more specifically 1 to 50 μm, but is not limited thereto.

<Lithium Metal Layer 60>

The thin lithium battery according to one aspect may include a lithium metal layer 60 integrated with the negative electrode current collector between the negative electrode current collector and the first separator.

The lithium metal layer 60 integrated with the negative electrode current collector may be formed by initial charging after the battery is manufactured. Accordingly, the thin lithium battery in which charging is not performed immediately after manufacturing the battery may not include a lithium metal layer, and one surface of the negative electrode current collector and one surface of the first separator may be in direct contact with each other to face each other.

During the initial charging of the lithium battery, lithium ions move from the positive electrode to the negative electrode current collector, receive electrons from the negative electrode current collector, and are converted into metallic lithium. This may correspond to a process in which metallic lithium is electrodeposited on the negative electrode current collector by the charging reaction of the battery. Accordingly, the lithium metal layer 60 may be formed in a region opposite to the positive electrode on the negative electrode current collector by charging the battery, formed to have substantially the same size as the positive electrode, and formed integrally with the negative electrode current collector.

In addition, during the charging reaction of the battery, a flux of lithium ions is formed from the positive electrode side to the negative electrode side, and the lithium ions reaching the negative electrode side receive electrons through the current collector and are converted into metallic lithium, so nucleation and growth of metallic lithium occur simultaneously on the negative electrode current collector. The lithium metal layer may have porosity by inevitably forming empty spaces between metal lithium particles (grains) due to simultaneous and random nucleation and growth of metal lithium. In addition, the lithium metal layer may have a macroscopically flat film (layer) form due to physical restraint by one surface of the first separator opposite to one surface of the negative electrode current collector. As described above, the lithium metal layer may have a porous flat structure in the form of a macroscopically flat film having irregular pores due to empty spaces between metallic lithium particles (grains).

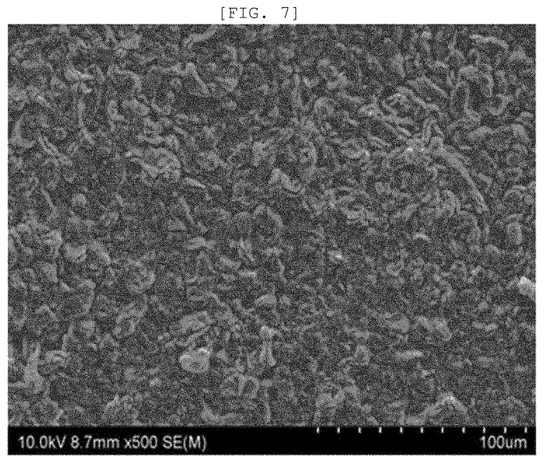

As described above, the porous flat structure means a lithium metal layer formed by the first charging after the battery is manufactured. As illustrated in FIG. 7 of the present invention, the battery of the present invention has a dense flat structure according to the use of the gel polymer electrolyte, and has a porosity different from that of metal foil.

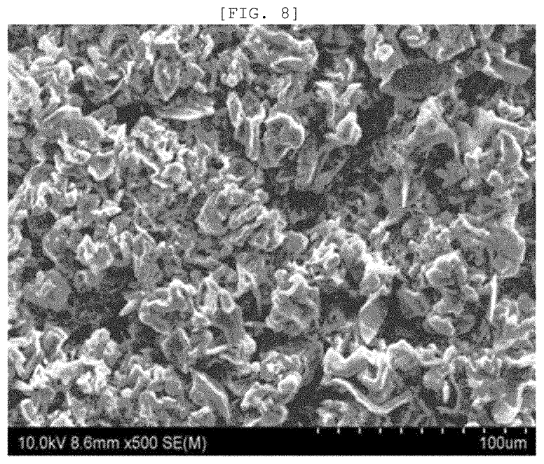

As illustrated in FIG. 8, the dense flat structure means that the lithium metal layer is formed in a denser and flat structure compared to the lithium metal layer formed on the negative electrode current collector when the liquid electrolyte is used.

In one aspect of the present invention, the thickness of the lithium metal layer may be 1 to 100 μm, but is not limited thereto.

In the thin lithium battery including the lithium metal layer having the porous flat structure according to an embodiment of the present invention, since the lithium metal layer is made only of lithium (lithium involved in the charging/discharging reaction) required for capacity, the battery is used (after discharging), the lithium metal layer disappears substantially, and is thus safer even after disposal. In the case of the conventional lithium primary battery, since an excess of lithium metal is used than the actual battery capacity using a lithium foil negative electrode, even after the lithium primary battery is discharged, an excess lithium metal layer (metal lithium layer that does not contribute to the charge-discharge reaction) exists. Disposing of the lithium primary battery in such a situation is very dangerous because a reaction with external moisture occurs.

Therefore, since the thin lithium battery according to an embodiment of the present invention includes a lithium metal layer having a porous flat structure, safety is greatly improved even when the battery is being used or disposed after use, compared to a lithium primary battery using a conventional lithium metal. Accordingly, in the thin lithium battery according to an embodiment of the present invention, the amount of metallic lithium remaining on the negative electrode current collector after completely discharging may be within 10 wt % of metallic lithium in the state before discharging (state of charge), preferably within 5 wt/o, and more preferably within 2 wt %, but the present invention is not limited thereto.

<Lower Sheet 70>

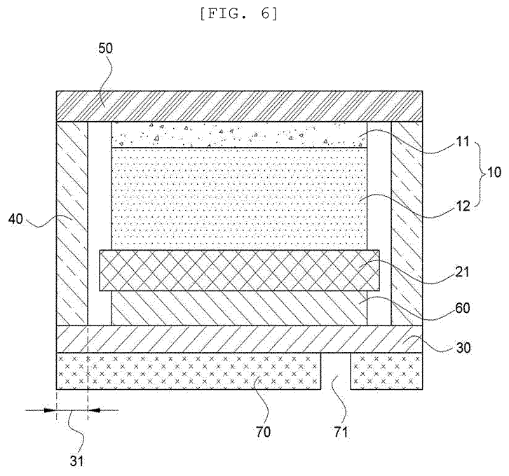

The first aspect of the present invention may further include the lower sheet 70 as necessary as illustrated in FIG. 6.

The lower sheet 70 may be closely adhered to the negative electrode current collector, and an opening 71 may be formed in a portion of the lower sheet to expose a portion of the negative electrode current collector to the outside.

One aspect of the lower sheet 70 may include an insulating layer. By including the insulating layer, it is possible to protect the negative electrode current collector from external substances and to electrically insulate the negative electrode current collector from the outside. In this case, the insulating layer may be partially open so that a part of the negative electrode current collector is exposed to the outside including a groove in which the insulating layer is not formed.

Another aspect of the lower sheet 70 may be a laminate including a barrier layer and a sealing layer. In addition, if necessary, a base layer may be further provided on the barrier layer. In this case, the laminate may be partially open so that a part of the negative electrode current collector is exposed to the outside including a groove in which the laminate is not formed. Since the barrier layer, the sealing layer, and the base layer are the same as those described in the upper sheet, further descriptions will be omitted.

<Manufacturing Method of First Aspect>

The manufacturing method of the thin lithium battery of the first aspect includes:

(S1) preparing a positive electrode-electrolyte conjugate including a first gel polymer electrolyte by applying and gellating a first gel polymer electrolyte composition on a positive electrode;

(S2) preparing a first separator-electrolyte conjugate including a second gel polymer electrolyte by applying and gellating a second gel polymer electrolyte composition on the first separator;

(S3) cutting the positive electrode-electrolyte conjugate and the first separator-electrolyte conjugate;

(S4) stacking a barrier rib sheet formed with a barrier rib pattern partitioned into a cell area having one or a plurality of openings on an upper surface of a negative electrode current collector;

(S5) forming a structure in which the first separator-electrolyte conjugate and the positive electrode-electrolyte conjugate are disposed in each of the one or a plurality of cell areas, and the negative electrode current collector, the first separator-electrolyte conjugate and the positive electrode-electrolyte conjugate are stacked;

(S6) stacking an upper sheet on the stacked structure; and

(S7) charging one or a plurality of cells.

In one aspect, in the operation (S1), the positive electrode refers to a laminate in which a positive electrode active material layer including lithium complex oxide is formed on a positive electrode current collector. That is, by applying the first gel polymer electrolyte composition on the positive electrode active material layer, a positive electrode-electrolyte conjugate in which the positive electrode active material layer and the first gel polymer electrolyte are integrated may be prepared.

In one aspect, in the operation (S2), the first separator-electrolyte conjugate in which the porous membrane and the second gel polymer electrolyte are integrated by applying the second gel polymer electrolyte composition to the porous membrane of the separator material may be prepared. In another aspect, in the operation (S2), the separator-electrolyte conjugate in which the membrane material and the second gel polymer electrolyte are integrated by swelling the dense membrane of the separator material with the second gel polymer electrolyte composition to introduce the second gel polymer electrolyte into the dense membrane may be prepared. In another aspect, the separator-electrolyte conjugate in which the separator and the second gel polymer electrolyte are integrated may be prepared by mixing the separator material with the second gel polymer electrolyte composition and then casting the mixture into the membrane.

In this case, the first gel polymer electrolyte composition may be formed of three aspects as follows. i) It may include linear polymers, solvents, and dissociable salts. In addition, if necessary, it may further include a performance enhancing agent. ii) It may include a crosslinkable monomer, a solvent, and a dissociable salt. In addition, if necessary, it may further include a performance enhancing agent. iii) It may include a linear polymer, a crosslinkable monomer, a solvent, and a dissociable salt. In addition, if necessary, it may further include a performance enhancing agent.

In the aspect i), it may be gelled after application and then gelled to form a gel polymer electrolyte including a linear polymer matrix, a solvent, and a dissociable salt.

In addition, in the aspect ii), it may be cured and gelled after the curing process after the application to form the gel polymer electrolyte including the crosslinked polymer matrix, the solvent, and the dissociable salt.

In addition, in the iii) aspect, it may be cured and gelled after the curing process and the gelation process after the application to form the gel polymer electrolyte including the polymer matrix of the semi-interpenetrating network (semi-IPN) structure, the solvent, and the dissociable salt.

In the operations (S1) and (S2), the application may be made not only by coating methods such as bar coating, spin coating, slot die coating, and dip coating of composition, but also by a printing method such as inkjet printing, gravure printing, gravure offset, aerosol printing, stencil printing, screen printing. In addition, as described above, by using a linear polymer or a crosslinking monomer, it is gelled or cured to form the linear polymer matrix, the crosslinked polymer matrix, or the polymer matrix having the semi-interpenetrating network (semi-IPN) structure. In addition, if necessary, it may further include a performance enhancing agent.

In this case, the second gel polymer electrolyte composition may have the same composition as the first gel polymer electrolyte composition, and may have different compositions, if necessary. That is, the first gel polymer electrolyte and the second gel polymer electrolyte may be different in at least one of a type of solvent; a type or concentration of dissociable salt; a type or content of linear polymer; a type or content of crosslinked polymer; and a type or concentration of performance enhancing agent.

More specifically, the ionic conductivity IC₁ of the first gel polymer electrolyte and the ionic conductivity IC₂ of the second gel polymer electrolyte may satisfy Equation 1 below.

IC₁−IC₂≥0.1 mS/cm [Equation 1]

When the difference in the ionic conductivity is 0.1 mS/cm or more, charge/discharge efficiency and battery life are increased, and at the same time, high battery safety may be secured.

In the operation (S3), each of the positive electrode-electrolyte conjugate and the first separator-electrolyte conjugate may be cut when cutting. The cutting may be performed by laser cutting, punching, etc., but is not limited thereto.

The operation (S4) is a process of forming a barrier rib pattern on the upper part of the negative electrode current collector, and the barrier rib pattern may be formed by stacking a barrier rib sheet on which the barrier rib pattern partitioned into a cell area having one or a plurality of openings is formed or by applying an adhesive composition that can adhere to the negative electrode current collector and the upper sheet while forming a barrier rib. The barrier rib sheet may be made of a polymer material that may be fused and sealed by heat.

In this case, the thickness of the barrier rib sheet is preferably determined in consideration of the thickness for housing the separator and the positive electrode, and it is preferable to set the thickness so that the positive electrode current collector may be in close contact with the upper sheet.

In addition, the plurality of cells means that two or more cell areas are formed so that several batteries may be manufactured at the same time.

In the operation (S5), the one or a plurality of cell areas means a cell area formed in the barrier rib pattern, and by disposing the previously prepared first separator and positive electrode-electrolyte conjugate, a structure in which the negative electrode current collector, the first separator-electrolyte conjugate, and the positive electrode-electrolyte conjugate are stacked is formed.

In the operation (S6), the negative electrode current collector and the upper sheet are adhered and sealed by stacking the upper sheet on the stacked structure and heat-compressing it.

Next, the operation (S7) is a process of forming the lithium metal layer on the negative electrode current collector by charging one or a plurality of cells. In this case, the plurality of cells may be charged after being cut into one cell, and if necessary, the cells may be cut and charged as many as necessary, or cut after being charged.

[Second Aspect of Thin Lithium Battery]

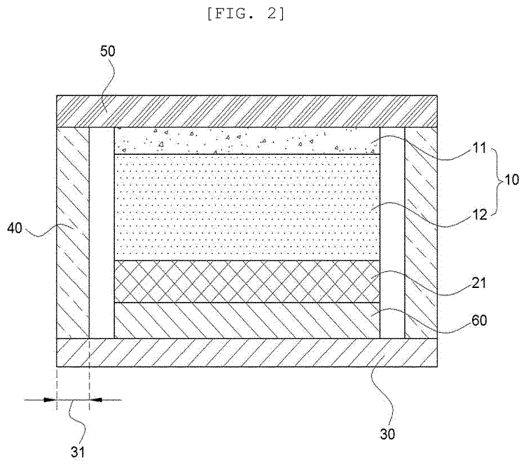

FIG. 2 is a cross-sectional view of a thin lithium battery 2000 according to a second embodiment of the present invention, and illustrates a case in which a separator has substantially the same size as a positive electrode. Here, ‘substantially’ means that the error range is within ±100 μm. That is, it means that the edges are substantially identical or that the error range is within ±100 μm.

The thin lithium battery 2000 according to the second aspect of the present invention has a structure in which a negative electrode current collector is exposed to the outside as illustrated in FIG. 2. Specifically, an upper sheet 50, a positive electrode 10, a first separator 21 and a negative electrode current collector 30 are sequentially stacked from the top, and a lithium metal layer 60 integrated with the negative electrode current collector is provided between the negative electrode current collector 30 and the first separator 21. In this case, the lithium metal layer 60 may be formed by first charging after assembling the battery. Also, the upper sheet 50 and the negative electrode current collector 30 may be sealed by a barrier rib 40.

In the second aspect of the present invention, as illustrated in FIG. 2, the positive electrode 10 is a positive electrode-electrolyte conjugate having a composite active material layer 12 in which a positive electrode active material layer including a lithium complex oxide and a first gel polymer electrolyte are integrated on a positive electrode current collector 11, and the positive electrode current collector 11 is in close contact with the upper sheet 50, the first separator 21 has substantially the same size as the positive electrode 10, and is a separator-electrolyte conjugate integrated with a second gel polymer electrolyte, the negative electrode current collector 30 includes a barrier rib 40 provided on a circumferential portion 31 of an upper surface thereof to be sealed in close contact with the upper sheet 50, and the positive electrode 10 and the first separator 21 are housed in a space sealed by the barrier rib 40, and a lithium metal layer 60 integrated with the negative electrode current collector is provided between the negative electrode current collector 30 and the first separator 21.

In addition, as illustrated in FIG. 2, by forming the first separator 21 and the positive electrode 10 to have substantially the same size, the positive electrode and the separator may be punched at the same time in the stacked state to produce a desired shape, and housed at the same time, so manufacturing may be simplified.

Each configuration constituting the thin lithium battery of the second aspect of the present invention is the same as described in the first aspect, and thus, redundant descriptions will be omitted.

<Manufacturing Method of Second Aspect>

The manufacturing method of the second aspect may be the same as that of the first aspect, and in this case, since the sizes of the positive electrode and the first separator are substantially the same, the positive electrode and the first separator may be manufactured by being simultaneously punched in a stacked state.

That is, the manufacturing method of the second aspect of the present invention includes:

(S1) preparing a positive electrode-electrolyte conjugate including a first gel polymer electrolyte by applying a first gel polymer electrolyte composition on a positive electrode;

(S2) preparing a first separator-electrolyte conjugate including a second gel polymer electrolyte by applying a second gel polymer electrolyte composition on a first separator;

(S3) cutting the positive electrode-electrolyte conjugate and the first separator-electrolyte conjugate;

(S4) stacking a barrier rib sheet formed with a barrier rib pattern partitioned into a cell area having one or a plurality of openings on an upper surface of a negative electrode current collector;

(S5) forming a structure in which the first separator-electrolyte conjugate and the positive electrode-electrolyte conjugate are disposed in each of the one or a plurality of cell areas, and the negative electrode current collector, the first separator-electrolyte conjugate and the positive electrode-electrolyte conjugate are stacked;

(S6) stacking an upper sheet on the stacked structure; and

(S7) charging one or a plurality of cells.

In this case, in the operation (S3), the positive electrode-electrolyte conjugate and the first separator-electrolyte conjugate may be formed to be substantially the same in size by cutting in a state in which the first separator-electrolyte conjugate is stacked on the positive electrode-electrolyte conjugate during the cutting.

When disposing the first separator-electrolyte conjugate and the positive electrode-electrolyte conjugate in each of one or a plurality of cell areas in the operation (S5), it is possible to arrange the first separator-electrolyte conjugate and the positive electrode-electrolyte conjugate at a time in a stacked state, so the manufacturing time may be shortened.

Other operations may be the same as in the first aspect, and thus further description will be omitted.

[Third Aspect of Thin Lithium Battery]

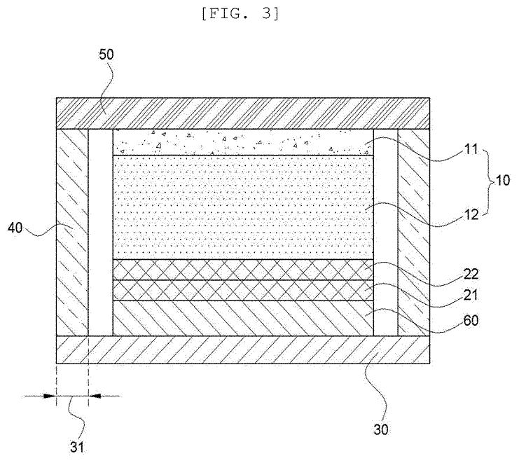

FIG. 3 is a cross-sectional view of a thin lithium battery 3000 according to a third embodiment of the present invention, and illustrates a case in which the number of separators is two. In this case, as illustrated, the size of the separators may be the same or different from each other. That is, the size of the first separator 21 may be substantially the same as the size of the second separator 22, or although not illustrated, the size of the first separator 21 may be larger.

The thin lithium battery 3000 according to the third aspect of the present invention has a structure in which a negative electrode current collector is exposed to the outside as illustrated in FIG. 3. Specifically, an upper sheet 50, a positive electrode 10, a second separator 22, a first separator 21, and a negative electrode current collector 30 are sequentially stacked from the top, and a lithium metal layer 60 integrated with the negative electrode current collector is provided between the negative electrode current collector 30 and the first separator 21. In this case, the lithium metal layer 60 may be formed by first charging after assembling the battery. Also, the upper sheet 50 and the negative electrode current collector 30 may be sealed by a barrier rib 40.

In the third aspect of the present invention, as illustrated in FIG. 3, the positive electrode 10 is a positive electrode-electrolyte conjugate having a composite active material layer 12 in which a positive electrode active material layer including a lithium complex oxide and a first gel polymer electrolyte are integrated on a positive electrode current collector 11, and the positive electrode current collector 11 is in close contact with the upper sheet 50, the first separator 21 and the second separator 22 have substantially the same size, and is a separator-electrolyte conjugate integrated with a second gel polymer electrolyte, the negative electrode current collector 30 includes a barrier rib 40 provided on a circumferential portion 31 of an upper surface thereof to be sealed in close contact with the upper sheet 50, and the positive electrode 10, the first separator 21, and the second separator 22 are housed in a space sealed by the barrier rib 40, and a lithium metal layer 60 integrated with the negative electrode current collector is provided between the negative electrode current collector 30 and the first separator 21. In addition, the second separator 22 may have substantially the same size as the positive electrode, and the first separator 21 may have substantially the same size as the positive electrode or may be larger than the positive electrode as illustrated in FIG. 1.

As illustrated in FIG. 3, by further including the second separator 22, the short circuit caused by lithium dentrite growth is suppressed to effectively increase the thickness of the lithium metal layer formed per unit area when applying a high-loading positive electrode or charging at a high voltage, thereby increasing the capacity of the manufactured unit cell. In addition, when the second separator 22 has substantially the same size as the positive electrode, the positive electrode and the separator may be punched at the same time in the stacked state to produce a desired shape, and housed at the same time, so manufacturing may be simplified.

As described above, the second separator 22 may be the same or different from the first separator 21 in size and material. In addition, the second separator 22 may be stacked to serve as a protective film during the manufacture of the positive electrode 10, and may be punched and used in a stacked state together with the positive electrode.

In addition, the second separator 22 may have a third gel polymer electrolyte integrated therein, and in this case, the third gel polymer electrolyte may be the same as or different from the first gel polymer electrolyte or the second gel polymer electrolyte described above. In addition, when used as a protective film, it may be formed by burying a part of the first gel polymer electrolyte applied to the positive electrode or the second gel polymer electrolyte applied to the separator.

<Manufacturing Method of Third Aspect>

One aspect of the manufacturing method of the third aspect includes:

(S1) preparing a positive electrode-electrolyte conjugate including a first gel polymer electrolyte by applying a first gel polymer electrolyte composition on a positive electrode, and preparing a positive electrode-electrolyte-second separator laminate by stacking a second separator on the positive electrode-electrolyte conjugate;

(S2) preparing a first separator-electrolyte conjugate including a second gel polymer electrolyte by applying a second gel polymer electrolyte composition on a first separator;

(S3) cutting the positive electrode-electrolyte-second separator laminate and the first separator-electrolyte conjugate;

(S4) stacking a barrier rib sheet formed with a barrier rib pattern partitioned into a cell area having one or a plurality of openings on an upper surface of a negative electrode current collector;

(S5) forming a structure in which the first separator-electrolyte conjugate and the positive electrode-electrolyte-second separator laminate are disposed in each of the one or a plurality of cell areas, and the negative electrode current collector, the first separator-electrolyte conjugate, and the positive electrode-electrolyte-second separator laminate are stacked;

(S6) stacking an upper sheet on the stacked structure; and

(S7) charging one or a plurality of cells.

In this case, in the operation (S3), in the case of the first aspect, after preparing the positive electrode-electrolyte conjugate, a protective film must be attached and removed before being disposed in the cell area, but in the case of the third aspect, the second separator may serve as a protective film without the hassle of attaching and removing the protective film, so the manufacturing time may be shortened.

In addition, in the operation (S1), when the second separator is stacked, the first gel polymer electrolyte composition is smeared on one surface of the second separator, and in the operation (S5), when the positive electrode-electrolyte-second separator laminate is stacked on the first separator-electrolyte conjugate, the second gel polymer electrolyte may be smeared on the other surface of the second separator. Accordingly, the second separator may be integrated with the third gel polymer electrolyte that is the same as or different from the first gel polymer electrolyte or the second gel polymer electrolyte.

In addition, the manufacturing method may further include a process of applying a separate third gel polymer electrolyte to the second separator. In this case, in the operation (S1), after stacking the second separator, the manufacturing method may further include a process of applying a third gel polymer electrolyte composition. Alternatively, it may be stacked in a state in which the third gel polymer electrolyte composition is applied before stacking the second separator.

Other operations may be the same as in the first aspect, and thus further description will be omitted.

Hereinabove, although the present invention has been described by specific matters, exemplary embodiments, and the accompanying drawings, they have been provided only for assisting in the entire understanding of the present invention. Therefore, the present invention is not limited to the exemplary embodiments. Various modifications and changes may be made by those skilled in the art to which the present invention pertains from this description.

Therefore, the spirit of the present invention should not be limited to these exemplary embodiments, but the claims and all of modifications equal or equivalent to the claims are intended to fall within the scope and spirit of the present invention.

### DETAILED DESCRIPTION OF MAIN ELEMENTS

10: positive electrode
11: positive electrode current collector
12: Composite active material layer
21: First separator
22: Second separator
30: negative electrode current collector
31: Circumferential portion of upper surface of negative electrode current collector
40: Barrier rib
50: Upper sheet
60: Lithium metal layer
70: Lower sheet
71: Opening

1. A thin lithium battery, comprising:
an upper sheet, a positive electrode, a first separator, and a negative electrode current collector which are sequentially stacked,
wherein the positive electrode is a positive electrode-electrolyte conjugate in which a positive electrode active material layer including a lithium complex oxide and a first gel polymer electrolyte are integrated on a positive electrode current collector, and the positive electrode current collector is in close contact with the upper sheet,
the first separator has substantially the same size as the positive electrode or is larger than the positive electrode, and is a separator-electrolyte conjugate integrated with a second gel polymer electrolyte,
the negative electrode current collector includes a barrier rib provided on a circumferential portion of an upper surface thereof to be sealed in close contact with the upper sheet, and the positive electrode and the first separator are housed in a space sealed by the barrier rib, and
a lithium metal layer integrated with the negative electrode current collector is provided between the negative electrode current collector and the first separator.

2. The thin lithium battery of claim 1, further comprising:
a second separator provided between the first separator and the positive electrode, wherein the second separator is housed in the space sealed by the barrier rib, and has substantially the same size as the positive electrode.

3. The thin lithium battery of claim 1, wherein the upper sheet is formed of a metal layer, and the positive electrode current collector and the metal layer are in close contact with each other to be electrically connected to each other.

4. The thin lithium battery of claim 3, further comprising:
at least any one joint provided in a portion in which the positive electrode current collector and the metal layer are in close contact with each other.

5. The thin lithium battery of claim 3, further comprising:
at least one conductive layer selected from a conductive adhesive layer, a conductive pressure-sensitive adhesive layer, a conductive paste layer, and an anisotropic conductive layer provided between the positive electrode current collector and the metal layer.

6. The thin lithium battery of claim 3, wherein the upper sheet further includes an insulating layer on an outermost layer, and a portion of the insulating layer is opened.

7. The thin lithium battery of claim 1, wherein the upper sheet is a laminate including a barrier layer and a sealing layer,
the barrier layer is made of a metal foil or a polymer material,
the sealing layer is made of an insulating material, and is made of a material that is adhered in close contact with the positive electrode current collector and one surface of upper portions of the barrier rib, and
an opening is formed in a portion of the upper sheet so that a portion of the positive electrode current collector is exposed to an outside.

8. The thin lithium battery of claim 7, wherein the upper sheet further includes a base layer, which is made of an insulating material, on an upper portion of the barrier layer.

9. The thin lithium battery of claim 1, further comprising:
a lower sheet adhered in close contact with the negative electrode current collector, wherein an opening is formed in a portion of the lower sheet so that a portion of the negative electrode current collector is exposed to an outside.

10. The thin lithium battery of claim 1, wherein the lithium metal layer has a thickness of 1 to 100 μm.

11. The thin lithium battery of claim 1, wherein the lithium metal layer has a porous flat structure.

12. The thin lithium battery of claim 1, wherein the negative electrode current collector is any one or a combination of two or more selected from the group consisting of aluminum, stainless steel, copper, nickel, and titanium.

13. The thin lithium battery of claim 1, wherein the negative electrode current collector is a laminate including a first negative electrode metal layer and a second negative electrode metal layer,
the first negative electrode metal layer is any one or a combination of two or more selected from the group consisting of copper, nickel, and stainless steel,
the second negative electrode metal layer is any one or a combination of two or more selected from the group consisting of aluminum, stainless steel, copper, nickel, and titanium, and
the first negative electrode metal layer and the second negative electrode metal layer have different compositions.

14. The thin lithium battery of claim 1, wherein the negative electrode current collector further includes a terminal unit extending further than an outer end of the barrier rib.

15. The thin lithium battery of claim 3, wherein the metal layer of the upper sheet further includes a terminal unit extending further than an outer end of the barrier rib.

16. The thin lithium battery of claim 1, wherein the positive electrode current collector is a laminate including a first positive electrode metal layer and a second positive electrode metal layer, and
the first positive electrode metal layer and the second positive electrode metal layer have different compositions.

17. The thin lithium battery of claim 1, wherein the first gel polymer electrolyte and the second gel polymer electrolyte include a solvent and a dissociable salt, and
the first gel polymer electrolyte and the second gel polymer electrolyte are a polymer matrix that further includes any one or two or more selected from the group consisting of a linear polymer and a crosslinked polymer.

18. The thin lithium battery of claim 17, wherein the first gel polymer electrolyte and the second gel polymer electrolyte are each applied, gelled, and then integrated.

19. The thin lithium battery of claim 17, wherein the first gel polymer electrolyte and the second gel polymer electrolyte have different ionic conductivity.

20. The thin lithium battery of claim 19, wherein ionic conductivity IC₁ of the first gel polymer electrolyte and ionic conductivity IC₂ of the second gel polymer electrolyte satisfy Equation 1 below.
IC₁−IC₂≥0.1 mS/cm [Equation 1]

21. The thin lithium battery of claim 17, wherein the first gel polymer electrolyte and the second gel polymer electrolyte are different in at least one of a type of solvent; a type or concentration of dissociable salt; a type or content of linear polymer; and a type or content of crosslinked polymer.

22. The thin lithium battery of claim 17, wherein the first gel polymer electrolyte and the second gel polymer electrolyte further include a performance enhancing agent, and a type or concentration of the performance enhancing agent of the first gel polymer electrolyte and the second gel polymer electrolyte is different.

23. A method for manufacturing a thin lithium battery, comprising:
(S1) preparing a positive electrode-electrolyte conjugate including a first gel polymer electrolyte by applying a first gel polymer electrolyte composition on a positive electrode;
(S2) preparing a first separator-electrolyte conjugate including a second gel polymer electrolyte by applying a second gel polymer electrolyte composition on a first separator;
(S3) cutting the positive electrode-electrolyte conjugate and the first separator-electrolyte conjugate;
(S4) stacking a barrier rib sheet formed with a barrier rib pattern partitioned into a cell area having one or a plurality of openings on an upper surface of a negative electrode current collector;
(S5) forming a structure in which the first separator-electrolyte conjugate and the positive electrode-electrolyte conjugate are disposed in each of the one or a plurality of cell areas, and the negative electrode current collector, the first separator-electrolyte conjugate and the positive electrode-electrolyte conjugate are stacked;
(S6) stacking an upper sheet on the stacked structure; and
(S7) charging one or a plurality of cells.

24. The method of claim 23, further comprising:
preparing a positive electrode-electrolyte-second separator laminate by stacking a second separator on the positive electrode-electrolyte conjugate in the operation (S1),
wherein in the operations (S3) and (S5), the positive electrode-electrolyte conjugate is the positive electrode-electrolyte-second separator laminate.

25. The method of claim 23, wherein in the operation (S7), a lithium metal layer integrated with the negative electrode current collector is formed on the negative electrode current collector by the charging.
